(19) United States
(12) Patent Application Publication
(10) Pub. No.: US 2005/0065678 A1
(43) Pub. Date: Mar. 24, 2005

(54) Enterprise resource planning system with integrated vehicle diagnostic and information system

(75) Inventors: Andrew Smith, Cedar Rapids, IA (US); Nik Neymeyer, Mechanicsville, IA (US); Dennis Essenmacher, Royal Oak, MI (US); Tracy Meade, Attica, MI (US); Rebecca Lohr, Cedar Rapids, IA (US); Sunil Reddy, Corpus Christi, TX (US); Madana Venkata, Coralville, IA (US); Corey Kirk, North Liberty, IA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: SNAP-ON TECHNOLOGIES, INC.

(21) Appl. No.: 10/853,700

(22) Filed: May 24, 2004

Related U.S. Application Data
(63) Continuation-in-part of application No. 10/823,804, filed on Apr. 12, 2004.
Application No. 10/823,804 is a continuation of application No. PCT/US04/11326, filed on Apr. 12, 2004.
Application No. PCT/US04/11326 is a continuation of application No. 10/091,096, filed on Mar. 4, 2002.
Application No. 10/091,096 is a continuation-in-part of application No. 09/640,785, filed on Aug. 18, 2000.
(63) Continuation-in-part of application No. 10/823,271, filed on Apr. 12, 2004.
Application No. 10/823,271 is a continuation-in-part of application No. 10/358,637, filed on Feb. 5, 2003.
(60) Provisional application No. 60/473,226, filed on May 23, 2003.
(60) Provisional application No. 60/351,165, filed on Jan. 23, 2002.
(60) Provisional application No. 60/462,561, filed on Apr. 11, 2003.
(60) Provisional application No. 60/462,582, filed on Apr. 11, 2003.
(60) Provisional application No. 60/462,583, filed on Apr. 11, 2003.
(60) Provisional application No. 60/354,673, filed on Feb. 5, 2002.

(51) Int. Cl. G06F 19/00

(52) U.S. Cl. 701/29; 701/1

(57) ABSTRACT

An enterprise-resource planning (ERP) system in which information processing and data management may be integrated or otherwise combined with a vehicle-diagnostic-and-information system is provided. The ERP system includes a first device for obtaining vehicle characteristic information from a vehicle, and a second device for integrating the vehicle characteristic information into an information management system. The first device is adapted to send the vehicle characteristic information over a communication link. The second device is adapted to receive from the first device over the communication link the vehicle characteristic information. When the second device integrates the vehicle diagnostic information into the information management system, the first and second devices are operable to function as the ERP system.

### CROSS REFERENCE TO RELATED APPLICATIONS

The present application:
(1) claims the benefit of U.S. Provisional App. Ser. No. 60/473,226, entitled “Vehicle Diagnostic, Prognostic and Telematic System”, filed May 23, 2004;
(2) is a continuation-in-part, claiming the benefit of commonly assigned, co-pending U.S. patent application Ser. No. ______, filed concurrently herewith, entitled “Wireless Communication Framework” (attorney docket 03-078-A1); which is a continuation of PCT Patent App. Ser No. US04/11326, entitled “Wireless Communication Framework,” filed Apr. 12, 2004; which:
   (i) is a continuation-in-part, claiming the benefit of commonly assigned, co-pending U.S. patent application Ser. No. 10/091,096, filed Mar. 4, 2002, entitled “Remote Monitoring, Configuring, Programming and Diagnostic System and Method for Vehicles and Vehicle Components,” which is a continuation-in-part, claiming the benefit of commonly assigned, co-pending U.S. patent application Ser. No. 09/640,785, filed Aug. 18, 2000, entitled “System, Method and Computer Program Product for Remote Vehicle Diagnostics, Monitoring, Configuring and Reprogramming;” and which
   (ii) claims the benefit of U.S. Provisional App. Ser. Nos.:
      (a) 60/351,165, entitled “Wireless Communication Framework”, filed Jan. 23, 2002;
      (b) 60/462,561, filed Apr. 11, 2003, entitled “System, Method and Computer Program Product for Remote Vehicle Diagnostics, Telematics, Monitoring, Configuring, and Reprogramming,”
      (c) 60/462,582, entitled “Wireless Communication Framework”, filed Apr. 11, 2003, and
      (d) U.S. Provisional Application No. 60/462,583 (Attorney Docket No. 03-050-D), entitled “Vehicle Interactive System”, filed Apr. 11, 2003; and
(3) is also a continuation-in-part, claiming the benefit of commonly assigned, co-pending U.S. patent application Ser. No. 10/823,271 filed Apr. 12, 2004, entitled “Vehicle Interactive System”, which
   (i) is a continuation-in-part, claiming the benefit of commonly assigned, co-pending U.S. patent application Ser. No. 10/358,637, filed Feb. 5, 2003, entitled “Vehicle Interactive System,” which claims the benefit of U.S. Provisional App. Ser. Nos.:
      (a) 60/354,673, filed Feb. 5, 2002, entitled “Vehicle-interactive System,” filed Feb. 5, 2002;
      (b) 60/462,561, filed Apr. 11, 2003, entitled “System, Method and Computer Program Product for Remote Vehicle Diagnostics, Telematics, Monitoring, Configuring, and Reprogramming,”
      (c) 60/462,582, entitled “Wireless Communication Framework”, filed Apr. 11, 2003, and
      (d) 60/462,583, entitled “Vehicle Interactive System”, filed Apr. 11, 2003.

The disclosures of the above-listed applications are incorporated herein by reference in their entirety. Further, the following related applications are hereby incorporated herein by reference in their entirety:
U.S. Utility application Ser. No. 10/084,800, filed Feb. 27, 2002, entitled “Vehicle Telemetry System and Method;”
U.S. Utility application Ser. No. 10/229,757, filed Aug. 28, 2002, entitled “Remote Vehicle Security System; and
U.S. Utility application Ser. No. 10/823,804, filed Apr. 12, 2004, entitled “System, Method and Computer Program Product for Remote Vehicle Diagnostics, Telematics, Monitoring, Configuring, and Reprogramming.”

### BACKGROUND

1. Technical Field

The present invention relates generally to computer data and information systems, and more particularly, to an enterprise-resource planning system in which information processing and data management systems may be integrated with vehicle diagnostic and information systems.

2. Related Art

It is common for companies to own large numbers or fleets of commercial motor vehicles. Typical examples of such companies include commercial courier services, moving companies, freight and trucking companies, truck leasing companies, as well as passenger vehicle leasing companies and passenger couriers. To maintain profitability, a company owning a vehicle fleet ideally minimizes the time spent in vehicle maintenance and repair. Maintaining optimum vehicle performance often involves removing vehicles from service to conduct fault analysis, schedule maintenance, diagnostics monitoring and parameter modifications.

To facilitate this objective, many companies implement on-board vehicle systems to maintain current information on the vehicle and to implement program level changes in various components of the vehicle. In general, these vehicle systems facilitate data or information transfer between the on-board vehicle systems and a vehicle diagnostic system. Traditional vehicle diagnostics systems have taken two major forms. The first of these includes very limited in-vehicle diagnostics displays (such as oil-pressure gauges and “check engine” indicators). And the second includes comprehensive service-bay scan tools in the form of handheld diagnostic devices or diagnostics software for personal computers. Each form serves a very specific audience. The former notifies the driver of serious problems, while the latter enables service technicians to diagnose and repair problems indicated by the vehicle's electronic control modules. While these systems function well, they have operational limits that can result in extra cost and downtime for the vehicle. For example, the in-vehicle diagnostics displays often reveal problems only after they have become serious, while there may have been early indications of a problem forming that could have been revealed by more sophisticated tools.

Generally, the vehicle diagnostic systems have a central computer system that communicates with the on-board vehicle systems. The central computer system typically receives data from and/or sends data to the on-board vehicle system through the central computer, which in turn, communicates with a user through a user device such as personal computer, personal digital assistant (PDA), or other electronic device. Various vehicle systems can be used to communicate various types of information, such as vehicle security information, vehicle position/location, driver trip information, jurisdiction boundary crossing information, fuel consumption information, driver messaging, concierge services, and information relating to local and remote diagnostics, such as monitoring the wear and tear of the vehicle and its various components, among others.

While these vehicle diagnostic systems provide a centrally located method for communicating with and maintaining centralized records of activities of a vehicle, some drawbacks exist. Specifically, many different types of software platforms may be used on the centrally located computer, the user device, and/or the vehicle system. Further, each of the vehicle diagnostic systems is typically written in proprietary and non-standard, customized software around a specific vehicle communications protocol (e.g., J1708, J1939, CAN, CANII, and etc). As on-board vehicle systems and communications protocols proliferate and change, the design and development life-cycle of vehicle-interaction applications begins anew, many times creating and recreating non extensible and non-scalable software. These proprietary and non-standard customized software applications suffer from not being able to support (i) more than one type of platform, (ii) standard operating systems, (iii) widely used embedded computers, Windows portable devices, and PalmOS devices, and (iv) other standardized frameworks.

Further, the onboard vehicle systems may include more than one vehicle controller. These vehicle controllers may or may not communicate according to the same protocol. Thus, different customized software applications may be needed to communicate with each of vehicle controllers when a single vehicle protocol may not be sufficient. In addition to the cost of such additional applications, customers may have to pay for the incremental cost of the vehicle information system's users (typically a service station or other attendant) time for switching between applications for each of the differing vehicle controllers. As the number of vehicle controllers and the wage of a user increases, this incremental cost may be quite substantial.

Moreover, because the customized software applications are generally written for specific platforms, its functionality is generally concentrated on a single platform. As such, legacy systems provided customized solutions for each specific software platform used on the mobile unit or central computer, which has resulted in many legacy systems being locked into a single comprehensive, non-distributed and non-scalable customized solution as the difficulty of accommodating all applications and networks is difficult.

As a result of the foregoing drawbacks, legacy vehicle diagnostic systems are not good candidates for integration into an enterprise-resource planning (ERP) system. The following was developed in light of these and other drawbacks.

### SUMMARY

Accordingly, one embodiment is directed to a system for monitoring, configuring, programming and/or diagnosing operation of at least one vehicle, comprising an on-board unit disposed on the vehicle to send and receive data corresponding to at least one vehicle operating characteristic, a plurality of modular applications, each application having an associated function that processes the data corresponding to said at least one vehicle operating characteristic obtained via the onboard unit, and an interface that allows selection among the plurality of modular applications to create a customized system.

Another embodiment is directed to an onboard unit disposed on a vehicle for use in a system for monitoring, configuring, programming and/or diagnosing operation of at least one vehicle, comprising at least one onboard unit interface to support communication between the on-board unit and at least one device outside the on-board unit, a processor that manages the data sent and received by the on-board unit via said at least one interface, and a memory coupled to the processor.

A further embodiment is directed to a method for monitoring, configuring, programming and/or diagnosing operation of at least one vehicle, comprising obtaining data corresponding to at least one vehicle operating characteristic from an on-board unit on the vehicle, providing a plurality of modular applications that are selectable by the user to create a customized system, and processing the data corresponding to at least one vehicle operating characteristic obtained via the on-board unit according to at least one function associated with at least one selected modular application.

Yet another embodiment is directed to a computer system having an application program, wireless communication framework for processing messages provided by the application program, and a plurality of transport modules that link the wireless communication framework to a respective plurality of networks for transporting the message to a second unit.

A method directed for transporting such messages from a first unit is also provided. This method may include the following. The message is first transported from an application program to a wireless communication framework. The message is then processed in the wireless communication framework to select one of a plurality of transport modules that correspond with one of a plurality of networks. The message is then transported through the selected network to a second unit.

In another embodiment, a method for dispatching a message from a first unit and receiving a message at a second unit is provided. Here, the first unit includes a first application program and a first part of a wireless communication framework. The second unit includes a second application program and a second wireless communication framework. The message is dispatched from the first application program and received in the first part of the wireless communication framework. The message is processed to select one of a plurality of transport modules that correspond to one of a plurality of networks. The message is transported through the network to the second unit. The message is received in a second part of the wireless communication framework and processed for the second application program. The message is provided to the second application program by the second part of the wireless communication framework.

Further embodiments and variations of the invention will be apparent from the drawings and description below.

### BRIEF DESCRIPTION OF DRAWINGS

Exemplary embodiments are described below in conjunction with the appended drawing figures, wherein like reference numerals refer to like elements in the various figures, and wherein:

FIG. 1 is a first block diagram of a first enterprise resource planning (ERP) system in accordance with an exemplary embodiment;

FIG. 2 is a flow diagram illustrating a flow for carrying out a vehicle servicing workflow in an enterprise-resource planning system in accordance with an exemplary embodiment;

FIG. 3 is second block diagram of a second ERP system in accordance with an exemplary embodiment;

FIG. 4 is a third block diagram illustrating a vehicle diagnostic and information system in accordance with an exemplary embodiment;

FIG. 5 is a fourth block diagram illustrating an exemplary architecture of an extensible vehicle data system framework in accordance with an exemplary embodiment;

FIG. 6 is a sixth block diagram illustrating a telematic, diagnostic and/or prognostic system; the capabilities and functions of which may be extended into an ERP system in accordance with an exemplary embodiment,

FIG. 7 is a seventh block diagram of system architecture of a telematic, diagnostic and/or prognostic system in accordance with an exemplary embodiment;

FIGS. 8A and 8B are eighth and ninth block diagrams of one embodiment of an on-board unit in accordance with an exemplary embodiment;

FIG. 9 is a tenth block diagram of a wireless communication system in accordance with an exemplary embodiment;

FIG. 10 is an eleventh block diagram of a wireless communication framework for a wireless communication system in accordance with an exemplary embodiment;

FIG. 11 is a second flow chart depicting the operation of a wireless communication system in accordance with an exemplary embodiment;

FIG. 12 is third flow chart depicting the operation of a wireless communication system in accordance with an exemplary embodiment;

FIG. 13 is a fourth flow chart depicting the operation of a wireless communication system in accordance with an exemplary embodiment;

FIG. 14 is a twelfth block diagram of a parameter retrieval process in accordance with an exemplary embodiment;

FIG. 15 is a thirteenth block diagram of a parameter retrieval process in accordance with an exemplary embodiment;

FIG. 16 is a fourteenth block diagram of a parameter retrieval process in accordance with an exemplary embodiment;

FIG. 17 is a graph illustrating the operation of a threshold alert process in accordance with an exemplary embodiment;

FIG. 18 is a fifteenth block diagram illustrating the operation of a tamper alert process in accordance with an exemplary embodiment;

FIG. 19 is a sixteenth block diagram illustrating a parameter change process in accordance with an exemplary embodiment;

FIG. 20 is a seventeenth block diagram illustrating one possible architecture for a remote diagnostics application to be used in accordance with an exemplary embodiment;

FIG. 21 is an eighteenth block diagram illustrating one possible architecture of a leased vehicle management application to use in accordance with an exemplary embodiment;

FIG. 22 is a nineteenth block diagram illustrating a telematic, diagnostic and/or prognostic system that is extended into the a vehicle diagnostic and information system in accordance with an exemplary embodiment;

FIG. 23 is a twentieth block diagram illustrating an exemplary workflow architecture for carrying out a vehicle servicing workflow in an enterprise-resource planning system in accordance with an exemplary embodiment;

FIG. 24 is a twenty-first block diagram illustrating a second workflow architecture for carrying out a vehicle servicing workflow in an enterprise-resource planning system in accordance with an exemplary embodiment;

FIG. 25 is a twenty-second block diagram illustrating an exemplary guided-diagnostics application architecture for carrying out guided-diagnostics in an ERP system in accordance with an exemplary embodiment;

FIG. 26 is a twenty-third block diagram illustrating an exemplary predictive-diagnostics application architecture for carrying out a predictive-diagnostics application in an ERP system in accordance with an exemplary embodiment;

FIG. 27 is a twenty-fourth block diagram illustrating a third workflow architecture for carrying out a vehicle servicing workflow in an enterprise-resource planning system in accordance with an exemplary embodiment.

### DETAILED DESCRIPTION

1 System Overview

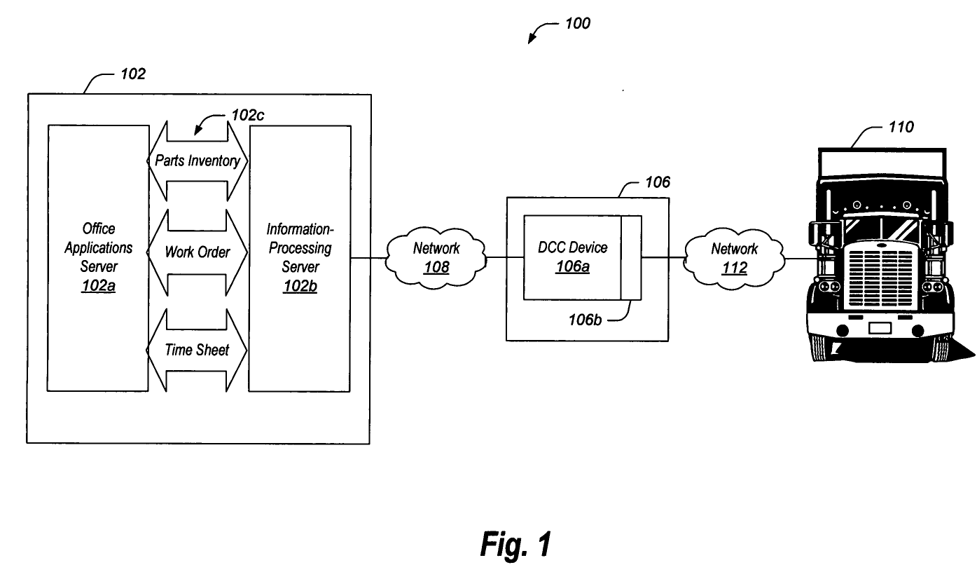

FIG. 1 is a block diagram of an enterprise-resource planning (ERP) system 100 in which information processing and data management may be integrated or otherwise combined with a vehicle diagnostic and information system, such as the vehicle diagnostic and information system (VDIS) 106. Deployment of the ERP system 100 may offer to vehicle repair facilities a substantial cost savings, improved workflow, and higher customer and employee satisfaction as compared to disparate and stand-alone silos of such legacy processes and systems. Included in the ERP system 100 is an enterprise information management system (EIMS) 102 which is communicatively coupled to the VDIS 106 via an integration communication link or network 108.

Through the deployment of the EIMS 102, the VDIS 106, and the communication network 108, the ERP system 100 may beneficially provide a highly adaptable and extensible system that not only delivers enhanced diagnostics over traditional diagnostics, but also enhanced value through the integration of vehicle applications, as described in more detail below, with enterprise-wide information processing applications, such as back and front office applications 102c. Such integration may, for example, merge diagnostic-type vehicle applications with service-bay workflow processes, service management processes, and/or one or more services provided by telematic, diagnostic and/or prognostic systems and methods.

In general, the vehicle applications may contain functionality for policy processing information, such as diagnostic data, telematic data and/or software routines, which may be passed between on-board electronics or electronic systems (e.g., electronic control modules) of vehicle 110 and the VDIS 106. The policy processing may include directives or other commands for carrying out business logic; business measures; look-up rules; value driven and cosmetic modifications; data resolution, analytics and presentation; component and track transaction activity for specific vehicles and/or fleets; knowledge-base generation and storage; user-requested vehicle queries; and other policy-based decision criterion. By being extensible, the VDIS 106 may provide a platform for which new vehicle applications, including reactive-type diagnostic applications (i.e., application for detecting failure after they occur) and predictive-type diagnostics applications (i.e., applications for anticipating failures before they occur), are easily developed, added and deployed.

With respect to the service-bay workflow integration, such enhanced value may be realized by providing to the VDIS 106 in electronic form (or through providing electronic access to the VDIS 106 to such) workflow information for carrying out servicing of a vehicle in a service bay of a vehicle repair facility. This information may include more or less information then was formerly carried by legacy systems in hardcopy form. The benefits of providing such workflow information in electronic form include (i) reduction and/or elimination of hardcopy paperwork, such as work order paperwork, parts ordering forms, time sheet forms, etc.; (ii) time savings by reducing and/or eliminating the process of transcribing into electronic form handwritten information, (e.g., vehicle diagnostic data, time entry information, parts ordering information, etc.); (iii) reducing the potential for losing information or incorrectly transcribing the information into electronic form; (iv) reducing overhead time to service a vehicle; (v) improving access to appropriate vehicle-specific documentation; and (vi) providing automated assistance for parts ordering and inventory tracking.

In the embodiment shown in FIG. 1, the EIMS 102 includes one ore more office application systems 102a for carrying out the enterprise-wide information processing applications, and an information-processing server 102b, which provides one or more interfaces to office application systems 102b. As described in more detail below, the EIMS 102, via the information-processing server 102b, may perform information processing and management of information passed between it and the VDIS 106. Using its information processing management, the EIMS 102 may facilitate incorporating or otherwise integrating the information passed to it from the VDIS 106 with the office applications 102c, such as work-order management applications, time sheet management applications, parts ordering and inventory management applications, and the like.

The EIMS 102 may be adapted or otherwise designed to be integrated with (e.g., ported into) a customer's existing office applications so as to form the ERP system 100, rather than supplying the entire ERP system 100. Alternatively, the EIMS 102 may be bundled with a one or more of the office applications for customers that do not have existing office applications.

By providing to the EIMS 102, in electronic form (or through providing electronic access to the EIMS 102 to) service-management information for the servicing of the vehicle, the enhanced value afforded by the service management integration may be realized. This realization of such benefits may occur on a number of levels. For instance, at a day-to-day workflow level, the integration beneficially provides for automated capture of information, including, for example, vehicle diagnostic, characteristic and status information; work order information; time sheet information; etc. This capture may then be used by the EIMS 102 for carrying out automatic coordination between the vehicle applications and office applications 102c. Moreover, the EIMS 102, via the data capture, may provide for automatic coordination between the work order processing and account processing to take into account the costs involved in servicing the vehicle, such as the cost of a service technician's time spent servicing the vehicle, and the cost of parts.

Over a long term workflow level, additional integration benefits can be realized by analyzing a vehicle's information history (e.g., its service history). The vehicle's information history may be created, complied and maintained by an information history application using the data capture noted above. The vehicle's information history may be analyzed for a myriad of purposes, including, for example, the purpose of (i) performing original equipment manufacturer (OEM) failure trend analyses so as to provide input to OEM's warranty and design programs; (ii) performing predictive service analysis, which may include identifying potential failures or service needs of the vehicle or vehicle components, and formulating a diagnostic or service routine or plan to quickly determine one or more corrective actions so as to be able to repair the vehicle.

With regard to integration of telematic, diagnostic and/or prognostic systems and methods, which will be described in more detail below, the ERP system 100 may provide to an end customer of such system a number of benefits that stem from the ability to communicate and interrogate the on-board electronics or electronic systems of vehicle 110. These benefits may be realized by extending the telematic, diagnostic and/or prognostic capabilities into the VDIS 106 and vice-versa. The capabilities may include the functions of (i) providing, in electronic form, advance warning of vehicle problems (e.g., faults) so that a service schedule of a vehicle repair facility can be coordinated in advance of, rather than after, arrival of the vehicle at the vehicle repair facility; (ii) providing, in electronic form, pre-arrival vehicle diagnostics and status information to the EIMS 102 for integration into the office applications 102c; (iii) providing the service-bay technician with access to pre-arrival fault and diagnostic data to assist in the diagnosis and repair process so that less time is spent diagnosing the problem after arrival of the vehicle; and/or (iv) remotely capturing diagnostic data to assist in troubleshooting problems that occur intermittently or only while the vehicle is on the road.

2 System Architecture

The realization of the above-listed and other benefits may be brought about by the architectural components of the ERP system 100. Included in the ERP 100 are the EIMS 102, the VDIS 106, and the communication network 108, which are described in detail above and in more detail below.

The VDIS 106 may be deployed with a diagnostic and command-and-control (DCC) device 106a for carrying out the vehicle applications, and a vehicle adapter 106b for adapting the DCC device 106a to a particular (e.g., manufacturer, make, and/or model of the) vehicle. The vehicle adapter 106b may contain hardware and software for coupling the DCC device 106a to the one or more vehicle communication buses to which on-board electronics or electronic systems of the vehicle 110 may be connected.

For example, the vehicle adapter 106b may be an industry standard serial data module, or variant thereof, for vehicle buses based upon Society of Automotive Engineering standards, such SAE J1708 or Heavy Duty Application Standards. For existing application, future high-speed-bus applications, and applications with other interfaces, an Automotive Serial Data Module (ASDM) or variant thereof may be used. One benefit of the ASDM is that it provides additional filtering and compound operation capabilities that allow the DCC device 106a to process vehicle information destined for or retrieved from the vehicle buses without being overwhelmed by a high-speed data transfer. Although shown separately, the DCC device 106a may be co-located with, integrated with, integral to or otherwise combined with the vehicle adaptor 106b (hereinafter collectively referred to as the DDC device 106a).

The DCC device 106a may be embodied as computing platform that is distributed among a plurality of nodes or, alternatively, concentrated on a single node. All or portions of the DCC device 106a may be temporarily connected or, alternatively, affixed to a vehicle 110. Being a computing system or device, the DCC device 106a may include software operating on a processing system, e.g., a general purpose computing platform, a specialized computing platform, an open source, e.g., a Linux, computing platform, a proprietary computing platform, and the like, for carrying out the vehicle applications and the functions thereof. The vehicle applications may be maintained in memory of the DCC device 106a, and thus, may be concentrated on a single node or distributed among one or more of the plurality of nodes. Alternatively, the vehicle applications may be maintained in the VDIS 106 in another data store or computing platform (not shown). When needed, the DCC device 106a may obtain the vehicle applications from such other data store or computing platform.

Included in the vehicle applications is logic that directs the DDC device 106a to interrogate the on-board electronics or electronic systems of the vehicle 110 so as to obtain the vehicle diagnostic, characteristic, and status information (collectively referred to as vehicle data), which may include, for example, standardized or proprietary vehicle status and trouble codes. The vehicle data may be used by the vehicle applications to aid in the diagnosis and resolution of the problem or servicing event. The vehicle data along with resolution and vehicle diagnosis information may be supplied to the EIMS 102 for integration into the ERP 100 in general, and the office applications on the office application systems 102a in particular.

To allow the vehicle applications to carryout this interrogation and transfer vehicle data, the DDC device 106a and/or the vehicle applications may include logic for effectuating (e.g., establishing, maintaining and tearing down) communications between the DCC device 106a and the onboard electronics or electronic systems of the vehicle 110. Such communications and vehicle diagnostic information transfer may occur over a wired or wireless vehicle-communication link (or network) 112.

To facilitate the integration with the office application systems 102a, the DCC device 106a may also include logic for carrying out communications with the EIMS 102. This logic may be configured to exchange information, including the vehicle data, between the DCC device 106a and an information-processing server 102b of the EIMS 102. This exchange of information may occur over the integration-communication network 108, and thus, the DCC device 106a may include logic for facilitating communications over the integration-communication network 108 as well.

For example, the DCC device 106a may be deployed as a handheld device, such as a pocket personal computer, personal digital assistant, or a sophisticated scan-type tool, which may be removably adapted to the vehicle 110. For example, the DCC device 106a may be embodied as a ruggedized handheld computer, such as a Symbol 1740, which runs a Palm operating system, or a Symbol 2840, which runs a Windows CE operating system.

The ruggedized handheld computer may be equipped with a plurality of communications interface adapters for communicating with on-board electronics or electronic systems of the vehicle over the vehicle-communication network 112 (via the vehicle adaptor 106b), and for communicating with the EIMS 102 over integration-communication network 108.

The DCC device 106a may also include one or more interfaces adapters for communicating with other portions of the VDIS 106 to obtain and update vehicle applications, as needed, rather than keeping resident all the vehicle application. This beneficially takes advantage of low cost and low power environment and the flexibility of handheld-type devices. Although, given the recent advances in computing-platform memory and processing power, the DCC device 106a may maintain all the vehicle applications locally on the computing platform. As such, updates and new vehicle applications can be added to the DCC device 106a on an as needed basis.

In an alternative embodiment, the DCC device 106a may be deployed as a client/server or distributed-computing system. In such a system, a first peer or first peer-portion of the system may be positioned aboard the vehicle 110. This first peer or first peer-portion (in either of a client/server or distributed computing mode) may be communicatively coupled to the onboard electronics or electronic systems of the vehicle 110 via a first part the vehicle-communication network 112. The first peer or first peer-portion may be also communicatively coupled to a second peer or second peer portion of the client/server or distributed-computing system via a second part of the vehicle-communication network 112. This combination of couplings may facilitate communication among the peer or peer-portions and the on-board electronics or electronic systems of the vehicle 110.

In addition, the second peer or second peer-portion of the client/server or distributed-computing system may be communicatively coupled to the information-processing server 102b via the integration-communication network 108. Thus, the vehicle data may be passed between the EIMS 102 and the on-board electronics or electronic systems of the vehicle 110.

Like the handheld embodiment, the DCC device 106a may also include one or more interface adapters for communicating with other portions of the VDIS 106 to obtain and update vehicle applications, as needed, rather than keeping resident all the vehicle application. However, the second peer or second peer-portion of the client/server or distributed-computing system may instead maintain the vehicle applications. When particular vehicle applications are needed, they are loaded in the first and second peer or peer-portions of the DCC device 106a. In this case, updates and new vehicle applications are added the second peer or peer-portion of the DCC device 106a.

In either case, the DCC device 106a may also include a user interface for interacting with a user, and/or a barcode or other-type scanner for logging and identifying the vehicle to which it is coupled. The DDC device 106a, however, may be set up to include the vehicle identification information so as to obviate a physical identification when, for example, the DCC device 106a is embodied as a set peers or peer portions.

In addition, the user interface may be optionally arranged with data entry device (e.g., a keyboard or keypad), a large display and rich graphical-user-interface (GUI) environment to provide (i) simultaneous display of vehicle data and other information; (ii) user-friendly access to features; (iii) streamlined data entry; and/or (iv) a graphical display of parameters (e.g., history, meters, bargraphs, etc.). Through the combination of the integration-communication network 108, vehicle-communication network 112 and/or other network (e.g., the Internet), the DCC device 106a may be given access to freeform, interactive and/or guided on-line documentation. This on-line documentation may be used to perform diagnostics using the vehicle data passed to the DCC device 106a as an input.

The integration-communication network 108 and vehicle-communication network 112 may both be partial or full deployments of most any communication or computer network, and thus, can include a few or many network elements, most of which are not shown. The format of these communication networks may be public or private, terrestrial wireless or satellite, and/or wireline, and may take into account any communication protocols for facilitating communications between the devices. Accordingly, each of the vehicle-communication and integration-communication networks 112, 108 may include circuit-switched as well as packet-data elements to provide transport between (i); the DDC device 106a and the onboard electronic systems and (ii) the DDC device 106a and the information-processing server 102b, respectively.

In one exemplary embodiment, the vehicle-communication and integration-communication networks 112, 108 may be deployed as a wireless local area network, based on, for example, Symbol's Spectrum 24 or an Institute of Electrical and Electronics Engineers (IEEE) 802.11 technology. As such, the DCC device 106a may include an IEEE 802.11 network adapter, and the EIMA 102 may include a wireless-access point (not shown) or other wireless network adapter that is coupled to the information-processing server 102b. The wireless access point (or other network adapter) acts as a gateway (e.g., providing access and connectivity) between the DDC device 106a and the information-processing server 102b.

The information-processing server 102b may include software that operates upon a processing system, e.g., a general purpose computing platform, a specialized computing platform, an open source, e.g., a Linux, computing platform, a proprietary computing platform, and the like. The information-processing server 102b may provide a host of applications including one or more applications that provide business logic for exchanging, capturing, retaining and processing information passed from between the DCC device 106a and the office application systems 102a. By way of example, the information-processing server 102b may be a Windows 2000-based server equipped with an SQL Server 2000 database management system (DBMS) and the business logic for servicing one or more DCC devices 106a on one side and the office application systems 102a on another.

The above-described architecture of the ERP system 100 is for exemplary purposes only. Other embodiments and/or more or less components of the ERP system 100 may be used.

3 Exemplary Operation

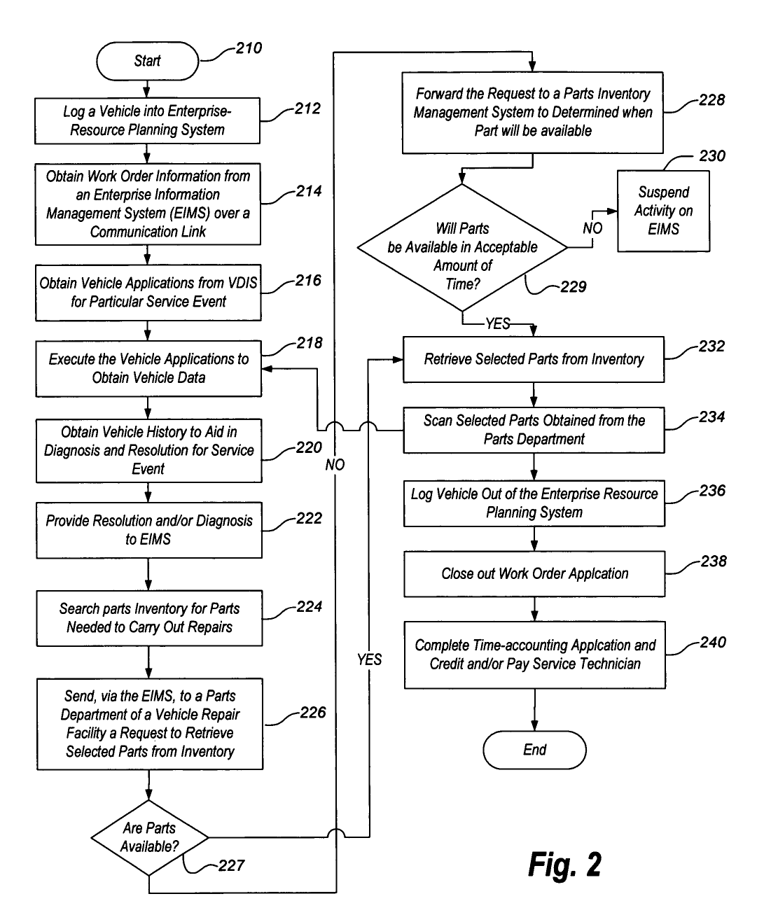

The ERP system 100 can support many possible front and back office applications, examples of which are described below and illustrated in FIG. 2. FIG. 2 is a flow diagram illustrating a flow 200 for carrying out a vehicle servicing workflow in an enterprise-resource planning system, such as the ERP system 100. Although the flow 200 may be carried out by different architectures, for simplicity, the following is described with reference to the ERP system 100. In this embodiment, the DCC device 106a may be embodied as the handheld device embodiment noted above.

The flow 200 starts at block 210 after a service manager or service technician has created, entered and/or stored work order information for the vehicle 110 in a work order application in the EIMS 102. The work order information, as known in the art, generally includes information or details about the customer, the vehicle 110 to be serviced, including the make, model, and year, along with a brief description of the problem or services to be performed. The work order application also typically includes a number of sections for listing problems identified, addressed, and resolved along with the listing the parts used to repair the vehicle 110. These sections may also include corresponding fields for listing the cost of the parts, the amount of time the service technician spent on servicing the vehicle, and the technician's hour wage so as to prepare an invoice for the services performed.

As one option, the sections for listing problems identified, addressed, and resolved, the listing of the parts used to repair the vehicle 110, and the corresponding fields for listing the cost of the parts, may be implemented by supplying a unique or standard listing of diagnostic codes that can be selected by the service technician or the DCC device 106a. For example, an “A.1” diagnostic code may be assigned to condition one, an “A.2” diagnostic code is assigned to condition two, an “A.3” diagnostic code is assigned to condition three, a “B.75” may be assigned to condition four, etc. By checking off a box next to the diagnostic code listings, the conditions may be entered into the work flow application. In implementing these unique or standard codes, the service technician, the service facilities supporting staff and the insurance company will know how to properly account for the services performed.

After the vehicle 110 enters a service bay, the service technician logs the vehicle into the ERP system 100, as shown in block 212. To do this, the service technician may enter the vehicle identification into the DCC device 106a via the user interface. Alternatively, the service technician may scan a barcode or other the vehicle identification tag using the scanning device coupled to the DCC device 106a. In addition identifying the vehicle 110, the service technician may also have to confirm his or her authorization by supplying authentication and security credentials (e.g., user name and password) to gain access to and log the vehicle 110 into the ERP system 100.

Responsive to logging in, the DCC device 106a logs a start time indicating the begin time of the servicing. This start time may be entered or input into a time-accounting application, which may be concentrated in either or distributed in both of the DCC device 106a and the information-processing server 102b. The start time may be used later to calculate the amount of time the service technician spend servicing the vehicle 110.

After the start time is logged, the DDC device 106a obtains the information contained in the work order for the identified vehicle 110 (hereinafter referred to as work order information) from the EIMS 102, as shown in block 214. More particularly, the DDC device 106a may open a local copy of a work order application and populate its fields with the work order information obtained from the information-processing server 102b. To do this, the DCC device 106a may query, request, retrieve and/or download such work order information from information-processing server 102b via the integration-communication network 112. Alternatively, the work order information may be automatically delivered or “pushed” from the information-processing server 102b to the DCC device 106a using push-type communication software deployed in both devices.

After obtaining the work order information, the DCC device 106a, via its user interface, displays the work order information to the service technician for review and acceptance. Because the office application systems 102a and the DCC device 106a may use different user interface display technology, the DCC device 106a may format the work order information for its display to enable the service technician to review and/or accept the work order information.

If the service technician determines some or all of the work order information is incorrect or otherwise need to be changed, he or she may modify or supplement the work order information. To do this, however, the service technician may need to confirm authorization for making the changes by using proper authentication and/or security credentials to make modifications to the work order information.

Upon acceptance of the work order information or, alternatively, after the work order information is presented for review and acceptance, the DCC device 106a obtains one or more of the vehicle applications from the VDIS 106 for addressing the problem or servicing event for the vehicle 110, as shown in block 216. To obtain the vehicle applications, the DCC device 106a may query, request, retrieve and/or download from the data store 306d or computing platform of VDIS 106 that is housing such applications. This step may be skipped if the vehicle applications are already resident in the DCC device 106a.

At block 218, the DCC device 106a executes the vehicle applications to obtain the vehicle data, all or some of which may be used diagnosing and developing a resolution for the problem or servicing event. The vehicle applications may be performed with or without the assistance of or interaction with the service technician.

After completion of or as an input to the vehicle applications, the service technician may request the vehicle's information history, if any, so as to obtain (i) past vehicle data and resolution information for the vehicle 110 and/or (ii) other related information (e.g., warranty data) from similar type vehicles or components thereof. The past vehicle data and resolution information may be used to aid in the diagnosis and resolution of the present problem or servicing event, as shown in block 220.

To obtain the vehicle's information history, the DCC device 106a sends a query for the history to the information-processing server 102b over the integration-communication link 108. Responsively, the information-processing server 102b sends the vehicle's information history to the DCC device 106a over the same link. After receipt of the vehicle's information history, the DCC device 106a presents it to the service technician or inputs it into the vehicle applications requesting such information.

So that the vehicle's information history stays properly updated with the latest vehicle diagnostic information, the DCC device 106a may send some or all of the vehicle data to the information-processing server 102b. The information-processing server 102b updates vehicle's information history with this vehicle diagnostic information, and then stores it locally within memory of its computing platform or other data store of the EIMS 102. The vehicle data that is used to update the vehicle's information history may include, for example, current vehicle status and trouble codes; any programmable parameters and/or changes thereof; data list snapshots, and/or dynamically displayed data. To prevent erroneous vehicle data from being added to the vehicle's information history, the DCC device 106a may request the service technician select and/or confirm which of the vehicle data is to be added to the vehicle's information history.

Depending on the sophistication of the vehicle applications, the complexity of the problem or service event and/or the amount of interaction needed by the service technician, the vehicle applications may supply or, alternatively, the service technician may enter one or more resolutions aid/or diagnoses into the work order application running on the DCC device 106a, as shown in block 222.

In turn, the DCC device 106a sends the resolutions and/or diagnoses to the information-processing server 102b to update the appropriate fields in the work order application, as also shown in block 222. If needed, the DCC device 106a (or the service technician via the user interface) searches a parts inventory of the vehicle repair facility and/or any adjunct parts warehouse for the parts are needed to carry out the repairs, as shown in block 224. To access the parts inventory, the DCC device 106a may send one or queries for searching the vehicle inventory to the information-processing server 102b. The information-processing server 102b, in turn, forwards the queries to a parts inventory application and database of the office application systems 102a. The office application systems 102a (via the parts inventory application) sends one or more responses to the queries to the information-processing server 102b, which then forwards them to the DCC device 106a.

Regardless of whether the parts are available, the DCC device 106a sends a request for the parts to the information-processing server 102b, which in turn, forwards it to the parts inventory application. The parts inventory application issues the request to a parts department of vehicle repair facility, as shown in block 226. At decision block 227, a determination is made as to whether the parts are available.

If the parts are not available, then at block 228, the request may be forwarded to a parts inventory management system to determine when the parts will be available. Alternatively, the request may be forwarded to an ordering system to place a special order for the parts; assuming the customer of the vehicle has authorized payment of such special order. In either case, as shown in decision block 229, if delivery of the parts is longer than an acceptable period of time, e.g., an hour, then the DCC device 106 may send a notice to the information-processing server 102b to suspend activity on the vehicle 110. The information-processing server 102b may then temporarily deactivate the work order application for the vehicle 100, as shown in block 230. Consequently, the service technician may remove the vehicle 110 from the service bay to free it up for another vehicle.

If, however, the parts are available, then responsive to the communicated request, the parts department may retrieve the parts from inventory before the service technician arrives at the parts department, as shown in block 232, thereby shortening the time the service technician has to wait for parts to be pulled from inventory. After obtaining the parts from the parts department, the service technician may enter or scan the parts numbers into work order application, as shown in block 234. This beneficially provides an integrity check to ensure the correct parts were obtained from the parts department. The DCC device 106a then communicates the parts numbers used in the repair to (i) the parts inventory management system for inventory control and (ii) the work order application for invoicing the customer.

After completing repairs, the service technician may trigger or cause the DCC device 106a to return to block 218 to re-run the vehicle applications to clear trouble codes and/or verify correct vehicle operation. As with the initial scan, the DCC device 106a may send some or all of the vehicle data to the information-processing server 102b to update the vehicle's information history with the latest vehicle diagnostic information, as shown in block 220. The information-processing server 102b updates vehicle's information history with this vehicle data, and then stores it locally within memory of its computing platform or other data store of the EIMS 102. The DCC device 106a may again request the service technician select and/or confirm that all or some of the vehicle data be stored in the vehicle's information history.

Moving to block 222, the vehicle applications may supply or, alternatively, the service technician may enter one or more final resolutions and/or diagnoses into the work order application running on the DCC device 106a. The DCC device 106a then sends the final resolutions and/or diagnoses to the information-processing server 102b to update the appropriate fields in the work order application, as also shown in block 222. Unless new problems occur, the flow 200 skips to block 236. If, however, new problems occur, block 224-234 may be repeated until the vehicle 110 is repaired.

At block 236, the service technician logs the vehicle 110 out of the ERP system 100 by entering the vehicle identification into the user interface or scanning the barcode or vehicle identification tag associated with the vehicle 110. Upon log out, the DCC device 106a logs an end time; thereby indicating that the servicing is complete.

Responsively, the DCC device 106a sends a notification to the information-processing server 102b to close out the work order application for the vehicle 110, as shown in block 238. The information-processing server 102b, in turn, closes out its work order application, which causes an accounting application to create an invoice for the service performed.

In addition, the end time is entered or input into the time-accounting application. The time-accounting application may use the start and ending times to calculate the amount of time the service technician worked on the vehicle 110. This amount of time may then be used by a payroll application or payroll department to credit and/or pay the service technician for servicing the vehicle, as shown in block 240.

The above-described flow 200 is for exemplary purposes only. More or less process steps, and other embodiments and/or components of the ERP system 100 may be used.

4 Alternative System Architecture

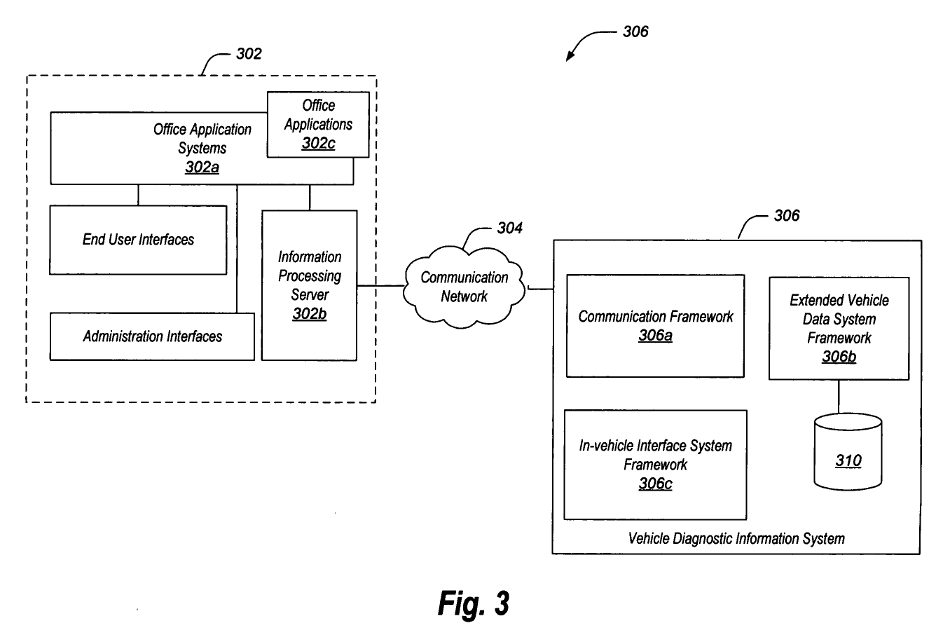

FIG. 3 is block diagram of an enterprise-resource planning (ERP) system 300 in accordance with an exemplary embodiment. In the ERP system 300, information processing and data management may be integrated or otherwise combined with an alternative vehicle diagnostic and information system, namely VDIS 306, for one or more vehicles. The ERP system 300 may include or have access to a communication link or a communication network 308 through which an alternative enterprise information management system, namely EIMS 302, and the VDIS 306 carry out the information processing and data management noted above.

Like the ERP system 100, the ERP system 300 can support many possible front and back office applications, such as the applications described in FIG. 2. In this embodiment, however, the functions carried out by the VDIS 106 may be carried out by the VDIS 306, and functions carried out by the EIMS 102 may be carried out by the EIMS 302.

The EIMS 302, which is substantially the same as the EIMS 102, may perform information processing and management of information passed between the vehicle applications and office applications, which are carried out by office application systems 302a. Using its information-processing server 302b, the EIMS 302 may facilitate incorporation or integration of vehicle data (passed to it from the VDIS 306) with one or more office applications 302c. Included in such office applications 302c are work-order management applications, time sheet management applications, parts ordering and inventory management applications, and the like.

The VDIS 306 may carry out the functions of (i) prioritizing and presenting diagnostics or logistics information to a user of the ERP system 300, including, for example, a vehicle operator, technician, fleet manager or other interested party; (ii) interacting with the user to analyze one or more vehicle conditions and/or or to run vehicle applications, such as telematic, diagnostic and/or prognostic applications; (iii) providing and facilitating wired or wireless download and upload of new functions and field upgrades; (iv) transmitting information between one or more vehicles and an enterprise information system, (v) reacting to updates of vehicle parameters from the enterprise information system; (vi) maintaining security over (e.g., limiting access to) information contained within its infrastructure, and (vii) executing other vehicle diagnostic and telematic operations.

To facilitate these functions, the VDIS 306 (and components thereof) may include a plurality of executable frameworks, which may be concentrated on or, alternatively, distributed among one or more of the components of the VDIS 306. These frameworks may include (i) an extended vehicle data system (xVDS) 306a; (ii) an in-vehicle interface system 306b; and (iii) a communication framework 306c.

Through the use of the frameworks, the VDIS 306 may reduce the cost of software development and maintenance. The software architecture of the VDIS 306 can minimize the engineering time for many likely changes in areas such as on-vehicle hardware and driver interface presentation. This type of architecture may be integrated into the software frameworks, allowing each framework to be upgradeable without affecting the other ones.

The xVDS 306a, as will be described in greater detail below, may be used to facilitate the creation and execution of one or more vehicle applications for each vehicle covered by the ERP system 300, without locking the system into any specific protocol, platform, or communication system. The functionality to support these vehicle applications may be implemented using a framework (“xVDS framework”) that interacts with data warehoused in a vehicle data store 306d (e.g., a database). This xVDS framework also provides the infrastructure for passing parameters to and from the VDIS 306 and on-board electronic or electronic systems that are positioned aboard each vehicle supported by the ERP system 300.

The xVDS framework may be cross-platform, thereby providing the same services on differing platforms. By abstracting operating system and hardware dependencies, the xVDS framework may be ported to new platforms. The xVDS framework may include one or more functional modules, Which allow the addition of new algorithms or removal of other functionality based on the desired behavior of the vehicle-interaction system. By allowing such scaling, the functional modules may allow for full customization of the vehicle-interactive application without the cost of writing and re-writing custom code.

Like the xVDS 306a, the in-vehicle interface system 306b may include a number of frameworks. These frameworks may facilitate prioritizing data in a user-optimized fashion and presenting information through graphical displays, gauges, buttons, indicators and the like. The communication framework 306b, like the other frameworks of the VDIS 306, may include a number of frameworks that allow for not only use, but cost-effective use, of multiple (wired or wireless) communication services via the communications network 304.

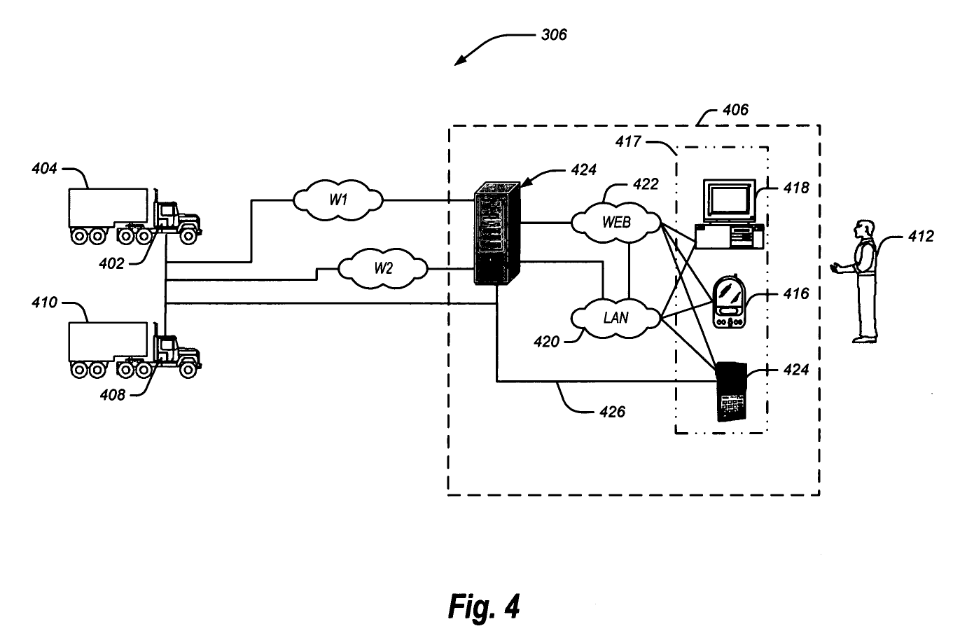

FIG. 4 is a block diagram illustrating a vehicle diagnostic and information system, such as the VDIS 306, in detail. The VDIS 306 may include one or more on-board diagnostic and command-and-control (DCC) devices, such as on-board DCC devices 402,406, and a computing system 406; all of which employ the xVDS framework. The combination of the DCC devices 402, 406 and computing system 406 may communicate, interact and/or interrogate on-board electronics or electronic systems of vehicles 404, 410 via (i) one or more networks W1 and W2; and/or (ii) a tethered connection 426.

Communication, interaction and/or interrogation of any of the onboard electronics or electronic systems 402, 408 may be accomplished through one or more access points of the computing system 406. Included among these access points are a user (i.e., man and/or machine) access point, and a vehicle access point.

The user access point 417 may be deployed as any one of a number of computers or other processing hardware, such a personal digital assistant (PDA) 416, a computer 418, and a handheld scan-tool device 424. The vehicle access point may be deployed as a host computer 414. The host computer 414 may be, for example, a fixed-based server system that can interface and access a number of first networks, such as networks W1, W2, and/or tethered connection 426, for exchanging vehicle data and other information with the on-board DCC devices 402, 406, and in turn, to the on-board electronics or electronic systems of vehicles 404, 410.

The fixed-based server system of the host computer 414 may also interface and access a number of networks, such as the Internet 422, a satellite network (not shown), a local area network (LAN) 420, and any other land-based or wireless connection systems, for exchanging vehicle data and other information with the user access point 417. Thus, the host computer 414 may act as a portal between the user access point and DCC devices 402, 408 so as to access onboard vehicle systems 402, 408 for exchanging vehicle data and information.

The computing system 206 also may contain at least one application program for running business applications related to user activities, which may include performing business logic, interfacing to the systems databases for fleet, vehicle, component and track transaction activity; conducting knowledge-base storage; and sending user-requested vehicle queries or functions to remote vehicles, such as vehicles 404, 410. These applications may be loaded into the computing system 206 from a separate computer system, such as the EIMS 302 (FIG. 3). Alternatively, the business applications can be concentrated on the any of computers and/or processing hardware within the computing system 406, such as host computer 414 or they may be distributed among two or more of the computers and/or processing hardware within the computing system 404.

As such, the user access point 417 may contain one or more software applications to process information relating to on-board electronics or electronic systems of vehicles 404, 410 received from host computer system 214 and/or DCC devices 402, 408. These devices, via the software applications, may exchange data and other information with the on-board vehicle systems 202, 208 directly or via host system 214. The user access point 417 may link to the host computer 414 by any of a plurality of known network models. For example, the PDA device 416, computer 418, and/or scan-tool device 424 may communicate with host computer 414 through a local area network (LAN) or the Internet. It is understood that other network models and corresponding devices may be used to communicate and transfer electronic information between user 412, host computer 414, and the DCC devices 402, 408.

The networks W1 and/or W2 may be embodied as any terrestrial or satellite, wired or wireless network. While technically considered a network, it also is noted that the computing system 406 may communicate with onboard electronics or electronic systems 402, 408 via a tethered connection 426. This tethered connection 426 may be, for example, a direct connection or a series of connections that ultimately connect the computing system 406 with on-board electronics or electronic systems 402, 408. The tethered connection 426 may be a serial or parallel type connection according to standard or proprietary configuration, such as Universal Serial Bus (USB), RS-232, parallel port, IEEE 1284, IEEE 1394, IEEE 488, and others. Communications transmitted over these connections may conform to one or more standard and/or proprietary protocols.

Vehicles 404, 410 may be components of a fleet and/or cars, boats, planes, any other known vehicle, and/or any other device having a diagnostic link. As depicted in the exemplary embodiment shown in FIG. 2, vehicles 404, 410 are trucks, which may be part of a commercial trucking fleet.

Each of the onboard electronics or electronic systems may be embodied as a vehicle controller, such as electronic control unit, a body controller, an anti-lock brake unit, a steering controller, a trailer controller, a trailer brake controller, a refrigeration controller, and the like. Each of the vehicle controllers may be linked to a plurality of sensors and other devices that provide vehicle data, characteristics and/or status information. Accordingly, each of the electronic systems may be provided with a real time computing system for processing system information and gathering data from the plurality of sensors and other devices. The real time computing system may provide data-stream processing, discrete measurement gathering, vehicle position information, real time analysis of data, and the like. The sensors and other devices maybe logically positioned throughout the vehicles 404, 410, and may send, receive, and gather various types of information such as vehicle mileage, maintenance scheduling, location, and other important information that the user 412 may want to access through host computer 414.

The DCC devices 402, 408 may act as vehicle servers, providing vehicle specific data and functionality in response to client or peer requests. The DCC devices 402, 408 may also include one or more vehicle data gateways for communicating with one or more of the vehicle controllers. These systems may be expandable or extended using xVDS framework as described in more detail below.

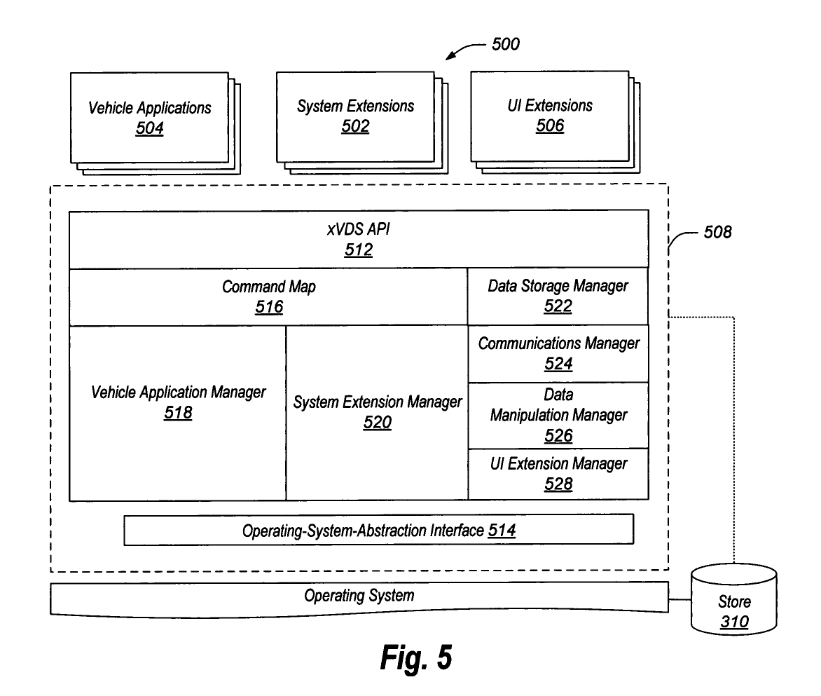

FIG. 5 is a block diagram illustrating an exemplary architecture of an xVDS framework 500, such as the xVDS framework described above. For simplicity, the following is described with reference to the VDIS system architecture shown in FIG. 4.

The xVDS framework 500 may be concentrated on one of the computers of the computing system 406, such as the host computer 414 or the computer 418. Alternatively, the xVDS framework 500 may be distributed among the components of the computing system 406, the DCC devices 402, 408, and data store 510. In any case, the computing system 406 may be adapted to run an operating system and a plurality of applications. As noted above, the computing system 406 may be any of a plurality of hardware platforms, and thus, may be adapted to run one or more of a plurality of standard and/or proprietary operating systems.

The xVDS framework 500 may include one or more system extensions 502, one or more vehicle applications 504, one or more user interface extensions 506, and an access-layer application 508. The system extensions 502 may provide a standardize method for adding or removing functionality of the xVDS framework 500, such as supplying communication protocols for accessing one or more of the vehicle controllers. The system extensions 502 may provide this functionality without modifying the operating system and/or the computing system 406. Using the system extensions 502 allows the xVDS framework 500 to be scalable, distributable, and portable.

The system extensions 502 may reside in an application space of memory when loaded into such memory or stored in a data store of the computing system 406, such as a disk drive and/or other mass storage media (not shown), when inactive. The system extensions 502 may be deployed as dynamic link libraries (DLLs) and/or shared libraries if the computing platform of the computing system 406 supports them. Alternatively, the system extensions 502 may be deployed as statically-linked libraries. The system extensions 502 may take other forms as well.

When needed, the system extensions 502 may be called by the access-layer application 508 and loaded into memory of the computing system to provide the additional functionality. The system extensions 502 may be written so that their functionality is shared by more than one application (e.g., one ore more of the vehicle applications 504) at the same time (i.e., reentrant code).

The vehicle applications 504 may contain functionality for the policy processing of one or more parameters, such as diagnostic and/or telematic data and/or software routines, which may be passed between the vehicle applications 504 and the onboard vehicle systems 402, 408. The policy processing may include business logic, business measures, look-up rules, value driven and cosmetic modifications, data resolution, analytics, presentation, component and track transaction activity for specific vehicles and fleets; knowledge-base generation and storage, user-requested vehicle queries or functions to remote vehicles, such as vehicles 404, 410, and other policy-based decision criterion.

The vehicle applications 504 may reside in the application space when loaded in memory or stored in a data store of the computing system 406, such as a disk drive and/or other mass storage media (not shown), when inactive. The vehicle applications 504 may be deployed as stand-alone executable programs, one or more dynamic link libraries and/or shared libraries if the computing platform of the computing system 406 supports them. Alternatively, the vehicle applications 504 may be deployed as statically-linked libraries. The vehicle applications 504 may take other forms as well

Alternatively, the vehicle applications 504 may be incorporated into or otherwise distributed among a vehicle data store, such as database 510, and the application code of the vehicle applications 504. This distributed code may work within the xVDS framework 306 to form a complete application. The data store may be concentrated or distributed among the computing system 406, DCC devices 402 or 408, and/or an external mass storage device (not shown). The vehicle database 510, which may be coupled to the computing system 406 and/or the DCC devices 402, 408, may house the at least one parameter passed between the vehicle applications 504 and the on-board electronics or electronic systems.

When activated (thorough, e.g., some data-driven automation or interaction with user 212), the vehicle applications 504 interface with the access-layer application 508 to cause themselves to be loaded into memory of the computing system 406 so as to provide the desired functionality. The vehicle applications 504 may be written so that their functionality is reentrant-type code.

The user interface extensions 506, like the system extensions 502, may provide a standard method for adding or removing user-interface functionality of the xVDS framework 306 to take input from and display results on a variety of computing platforms. The user interface extensions 506 may provide this functionality without modifying the operating system and/or the computing system 506. Using the user interface extensions 506 allows the xVDS framework 306 to be scalable, distributable, and portable.

The user interface extensions 506 may reside in the application space when loaded in memory or stored in a data store of the computing system 406, such as a disk drive and/or other mass storage media (not shown), when inactive. The user interface extensions 506 may be deployed as dynamic link libraries (DLLs) and/or shared libraries if the computing platform of the computing system 406 supports them. Alternatively, the user interface extensions 506 may be deployed as statically-linked libraries. The user interface extensions 506 may take other forms as well.

When porting the xVDS framework 306 to differing computing platforms, the user interface extensions 506 directed to the appropriate computing platform may be called by the access-layer application 508 and loaded into memory of the computing system to provide the user interface. The user interface extensions 506 may be written so that their functionality is reentrant.

The access-layer application 508 may be an intermediary application that is operable to pass one or more parameters, such as diagnostic and/or telematic data and/or software code, between the vehicle applications 502 and the on-board electronics or electronic systems. The access-layer application 508 may reside in the application space of the computing system 406 and/or the DCC devices 402, 408, and may be transparent to the user 412. For instance, the access-layer application 508 may loaded into memory of the computing system 406 and/or the DCC devices 402, 408 at initialization with the operating system, and then later invoked in response to running one or more of the vehicle applications 504. Alternatively, the access-layer application 508 may be loaded into memory of the computing system 406 and/or the DCC devices 402, 408 in response to running one or more of the vehicle applications 504. In yet another alternative, the access-layer application 508 may be loaded into memory computing system 406 and/or the DCC devices 402, 408, and invoked through some data-driven automation or user interaction.

The access-layer application 508 may be deployed as one or more stand-alone program, dynamic link libraries (DLLs) and/or shared libraries if the computing platform of the computing system 406 supports them. Alternatively, access-layer application 508 may be deployed as statically-linked libraries. The access-layer application 508 may take other forms as well.

To pass parameters such as diagnostic and/or telematic data and/or software code between the vehicle applications 502 and the onboard electronics or electronic systems, the access-layer application 508 on each of the DCC devices 402, 408 may include a first interface to communicate with the vehicle applications 504 and a second interface to communicate with the operating system. The first interface may be deployed as an xVDS application program interface (API) 512. The second interface may be deployed as an operating-system-abstraction interface 514.

Layered in between the first and second interfaces may be one or more functional modules that provide the functionality that may relieve the application developer from writing operating-system specific, protocol specific, communication specific, onboard vehicle system specific, and other non-vehicle application type code. As part of the access-layer application 508, these functional modules may be deployed as any of the stand-alone programs, dynamic link libraries and/or shared libraries, statically-linked libraries, and other equivalent programming structure. The functional modules may include a command map 516, a vehicle application manager 518, a system extension manager 520, a data storage manager 522, a communications manager 524, a data manipulation manager 526, and a user-interface manager 528. Other modules may be included as well.

The xVDS API 512 may provide a standard interface that allows the vehicle applications 504 and system extensions 502 use of the xVDS framework 306. Through function calls to the underlying functional modules, the xVDS API 512 may be used by the vehicle applications 504 and system extensions 502 to communicate with the on-board electronics or electronic systems via the operating system. For example, when one of the vehicle applications 504 desires to retrieve data from the on-board electronics or electronic system of the vehicle 402, the xVDS API 312 may receive one or more requests from the vehicle application to perform the retrieval. Though one or a series of function calls to the underlying modules, such as the communication manager 524, a communication may be set-up between the vehicle application and the onboard electronics or electronic system of the vehicle 404.

Similar to the xVDS API 512, the operating-system-abstraction interface 514 interfaces with the overlying functional modules and the underlying operating system. The operating-system-abstraction interface 514 may allow for easy porting of the xVDS framework 306 to a plurality of different platforms by abstracting operating system and hardware dependencies and configurations from the underlying operating system. An exemplary operating-system-abstraction interface 514 may be deployed as an operating system “thin layer,” which may isolate the xVDS framework 306 from operating system and platform differences.

Through function calls from the overlying functional modules, the operating-system-abstraction interface 514 interfaces with the underlying operating system to connect the vehicle applications 504 and system extensions 502 with the DCC devices 402, 408 and the on-board electronics or electronic systems.

Continuing with the example above, when one of the vehicle applications 504 desires to retrieve data from one of the on-board electronics or electronic systems, the operating-system-abstraction interface 514 may receive one or more function calls from one or more of the overlying functional modules, such as the communication manager 524, to set-up and connect the vehicle application to the on-board electronics or electronic system to perform the retrieval. After abstracting the operating system attributes, if any, the operating-system-abstraction interface 514 provides, though one or a series of function calls to the underlying operating system, a communication connection for the vehicle application 304.

Being part of the access-layer application 508, the xVDS API 512 and the operating-system-abstraction interface 514 may be deployed as any of the stand-alone programs, dynamic link libraries and/or shared libraries, statically-linked libraries, and other equivalent programming structure. Like the rest of the access-layer application 508, the xVDS API 512, the operating-system-abstraction interface 514, and the functional modules may be concentrated on a single computer within the computing system 406, or may be distributed among the computing system 406, the data store 310 and the DCC devices 402, 408. In addition, the functions carried out by these components may be distributed among various programming structures.

As noted, the functional modules may provide functionality so that the xVDS framework 306 may be independent of operating-system specific, protocol specific, communication specific, onboard vehicle system specific, and other non-vehicle application type code. Each of these functional modules may supply a given function for the framework. In the description of the functional modules that follow, each module carries out a tailored function. It should be noted, however, that these functional modules are not limited to a single program structure, but the given function may be carried out by and/or integrated with other functions in one or more program structures.

The command-map module 516 may generate and maintain a map within the access-layer application 508. In making the map, the command-map module forms relationships and associations between one or more functions of the vehicle applications 504, the system extensions 502, and/or the user interface extensions 506. In doing so, the command-map module 516 may make the functions of each of these components available to each of the other functional modules. The command-map module 516 may be called by other functional modules to locate and invoke the functions registered in the map.

The system-extension-manager module 520 includes logic for managing the execution of the system extensions 502 for the access-layer application 508. Managing the execution of the system extensions 502 may include (i) loading one or more of the system extensions 502 into memory upon being called or when invoked by the access-layer application 508; (ii) initializing the system extensions 502, which, for example, can include abstracting class libraries and objects from the invoked system extensions 502; (iii) shutting-down and unloading the system extensions 502 when being replaced, obsoleted, or otherwise not needed; and (iv) reporting the status of the system extensions 502 to the other functional modules, the vehicle applications 504, the operating system, DCC devices 402 or 408, and the onboard electronics or electronic systems.

Akin to the system-extension-manager module 520, the vehicle-application-manager module 518 includes logic for managing the execution of the vehicle applications 504 for the access-layer application 508. Managing the execution of the vehicle applications 504 may include loading one or more of the system extensions 502 and/or vehicle applications 504 into memory of the computer system 406, DCC device 402, and/or DCC device 408 upon being called or when invoked by the access-layer application 504 through data-driven automation or some type of user interaction.

In addition, the managing the execution of the vehicle applications 504 may include initializing class libraries, objects and other parameters abstracted from the invoked system extensions 502 and vehicle applications 504. Further, the vehicle-application-manager module 518 may provide logic for shutting-down and unloading the system extensions 502 when they are being replaced, obsoleted, or otherwise not needed; and reporting the status of the system extensions 502 and the vehicle applications 504 to the other functional modules, the vehicle applications 504, the operating system, and DCC devices 402, 408, and/or the on-board electronics or electronic systems.

The data-store-manager module 522 includes logic for managing the storage of parameters passed between the vehicle applications 504 and the on-board electronics or electronic systems. This includes task and device management to maintain current and historical states of the passed parameters. To carry out such management, the data-storage-manager module 522 may interact with the data store 310 via calls with the operating system.

The communication-manager module 524 includes logic for managing communication between the vehicle applications 504 and the on-board electronics or electronic systems. The communication-manager module 524 provides a protocol and platform independent method for establishing such communications. As a manager, communication-manager module 524 provides or invokes routines to set-up, maintain and tear down these communications between the vehicle applications 504 and the on-board electronics or electronic systems.

To carry out its management function, the communication-manager module 524 may include logic for determining from a host of available communication protocols (e.g., j1708, CAN I and II, etc.) specific communication protocols to communicate with any of the given vehicle controllers of the on-board electronics or electronic systems. In addition, the communication-manager module 524 may interface with the communication framework and the communication system 304 (FIG. 3) to provide the parameters to be passed in a format coinciding with the communication system 304.

For example, the communication-manager module 324 may provide to the communication framework j1708 code encapsulated in IEEE 802.11 wireless format for communication across the W1 and/or W2 networks. The communication-manager module 524 may manage and perform other communication functions for setting-up, maintaining and tearing down communications as well.

The data-manipulation-manager module 526 includes logic for managing format conversions of the parameters passed between the vehicle applications 504 and the on-board electronics or electronic systems. Given the parameters may be diagnostic and/or telematic information and/or executable code generated and exchanged among differing platforms (i.e., the computing system 406, the DCC devices 402, 408, the communication networks W1 and W2, the data store, the onboard electronics or electronic systems, etc.), the form of the parameters may differ depending on where it resides.

For instance, when residing in the on-board electronics or electronic systems, the parameters can be raw diagnostic information generated by one or more of the vehicle controllers, such as real-time measurements of oil-pressure. These measurements may be provided as a data-stream having a binary, hexadecimal, ASCII or other format. The vehicle application for this diagnostic information, however, contains a graphical user interface displaying an oil-pressure gauge having graduations in pounds per square inch.

The data-manipulation-manager module 526 may perform a format conversion of the raw diagnostic information so that the vehicle application can receive diagnostic information in a compatible format, such as pound per square inch. This may relieve the vehicle applications 504 from performing such conversion. Alternatively, data-manipulation-manager module 526 may provide one or more interim format conversions; leaving the vehicle applications 504 to perform its own conversions. The data-manipulation-manager module 526 may manage and perform other format conversions as well.

The user-interface-manager module 528 includes logic for managing the execution of the user-interface extensions 506 for the access-layer application. Some of the functions carried out by the user-interface-manger module 528 to manage the execution of user-interface extensions 506 may include (i) loading one or more of the user-interface extensions 506 into memory of the computing system 406 and/or the DCC devices 402, 408 upon being called or when invoked by the access-layer application 508; (ii) initializing the user-interface extensions 508, which, for example, can include abstracting class libraries and objects from operating system and the user-interface extensions 506; (iii) shutting-down and unloading the user-interface extensions 506 when being replaced, obsoleted, or otherwise not needed; and (iv) reporting the status of the user-interface extensions 506 to the other functional modules, the vehicle applications 504, the operating system, and the onboard electronics or electronic systems.

The modular approach provided by the functional modules of the xVDS framework 306 may allow full customization of vehicle applications, without the expense and inflexibility of platform and protocol specific software. Functional modules can be added, replaced and remove to allow for algorithms, settings and other information to be added, or removed. Further, the xVDS framework 306 may provide data-driven operation, which allows the application developer to concentrate design and implementation efforts on the business requirements of the application instead of spending coding time on vehicle-interaction. By using a thin Layer construct, framework becomes isolated from operating differences, which may allow for ease of porting to differing platforms.

As noted, the system extensions may allow functionality to be added at any time, without modifying (or revalidating) the operating system and or the existing xVDS framework 306. The system extensions 502 may be added or removed based upon the amount and type of processing required on the target platform. For example, a computing system that records vehicle information for later review doesn't need to carry the weight of the full implementation. Such a system, however, could be scaled to process and respond to certain conditions by adding the appropriate system extensions and vehicle application module(s).

5 Telematic, Diagnostic and/or Prognostic Systems

As noted above, telematic, diagnostic and/or prognostic systems and methods may be extended into an ERP system, such as the ERP system 100 or ERP system 300. Details of exemplary systems and methods described in the co-pending applications, which are noted in the Cross Reference to Related Applications section (above), and described below.

(a) System Functionalities and Architecture

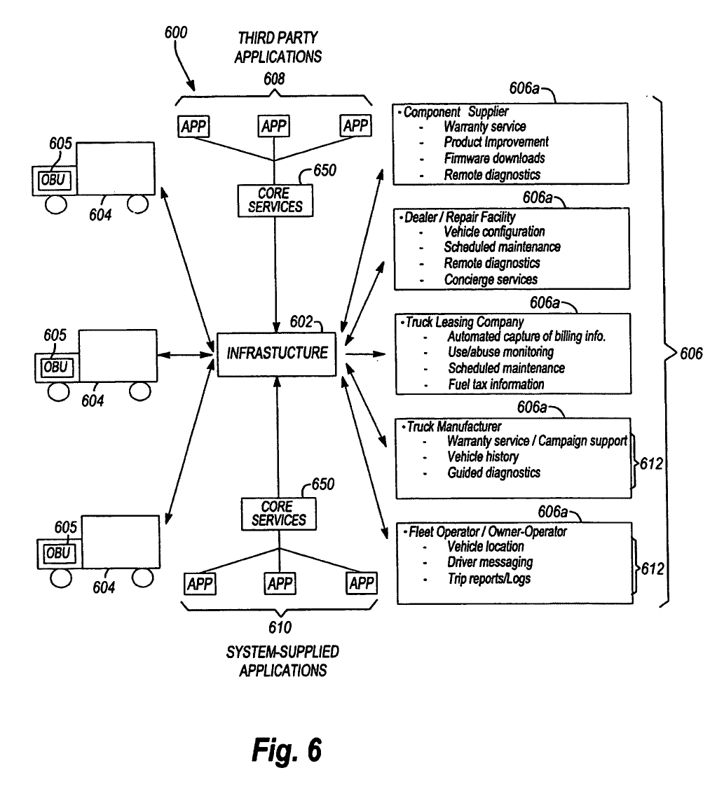

FIG. 6 is a block diagram of a telematic, diagnostic and/or prognostic system 600; the capabilities and functions of which may be extended into an ERP system, such as the ERP system 300. Generally, the system 600 allows monitoring and control of a vehicle fleet by displaying and controlling data according to a user's customized specifications. The system 600 may be designed with modular applications that interact with core data and services so that vehicle parameters can be monitored, analyzed and displayed in a format that is meaningful to a particular user and/or a particular industry. This flexibility allows different users and/or industries to use the same overall system 600 for vehicle and component monitoring despite their disparate vehicle data requirements.

Referring to FIG. 6, the system 600 may include an application service provider (ASP) infrastructure 602 that acts as a gateway between a plurality of vehicles 604, each vehicle having an associated on-vehicle computer (e.g., an on-board unit or “OBU” 605) and customizable interface 606. The interface 606 allows a user or machine 606a to select among various applications, such as third-party applications 608 as well as original, system-supplied applications 610, to obtain and analyze various data, e.g., vehicle data, from the vehicles 604. The applications 610 may include, for example, tools for obtaining real-time fleet characteristics, trend analysis and diagnostics, to perform manual, dynamic or rule-based configuration, as well as allow fleet managers to provide real-time driver/fleet notification.

To ensure that the user receives data that is meaningful to the user's specific application, the user interface 606 can be customized to operate applications selected by the user. In the example shown in FIG. 6, different types of users 606a may select different applications as a customized application group 612 to accommodate their specific data monitoring and reporting needs applicable to their own business.

For example, as illustrated in FIG. 6, a dealer/repair facility may select from the offered applications 608, 610, vehicle configuration, scheduled maintenance, remote diagnostics, and concierge services as its application group 612, while a truck manufacturer may select a different collection of applications 612, such as warranty service/campaign support, vehicle history, and guided-diagnostics. By offering a variety of modular applications 608, 610 that can be selected and combined according to the needs of a particular user, the same infrastructure 602 can be customized and used by different users for different purposes with little or no modification of the infrastructure 302. Further, by allowing users to access third-party applications 608 through the same infrastructure as system supplied applications 610, the system 600 can leverage services not provided by the system 600, further increasing flexibility and adaptability.

Further, in an embodiment of the system 600 that uses an ASP-based model, an application service provider provides and allows access, on a subscriber basis, to this remote vehicle diagnostics, monitoring, configuration and reprogramming tool via the Internet. That is, the application service provider provides the hardware (e.g., servers, an on-vehicle computer) and software (e.g., database) infrastructure, application software, customer support, and billing mechanism to allow its customers (e.g., fleet managers, vehicle distributors, vehicle dealers, original equipment manufacturers (“OEMs”), leasing/rental companies, and the like) to remotely access the vehicles within a fleet. The tool can be used by subscribers to select and access one or more of the modular applications 608, 610.

Note that an ASP-based model can eliminate the need to physically distribute software to users. Instead, new features and updates can be immediately available to users because the system resides and runs on an application server. In one embodiment, applications that are not on the application server can reside on the OBU 605 in on-board unit applications. The on-board unit applications can be loaded onto the OBU 605 during vehicle installation, and additional applications or application updates can be downloaded onto the OBU 605 through a wireless network connection, for example.

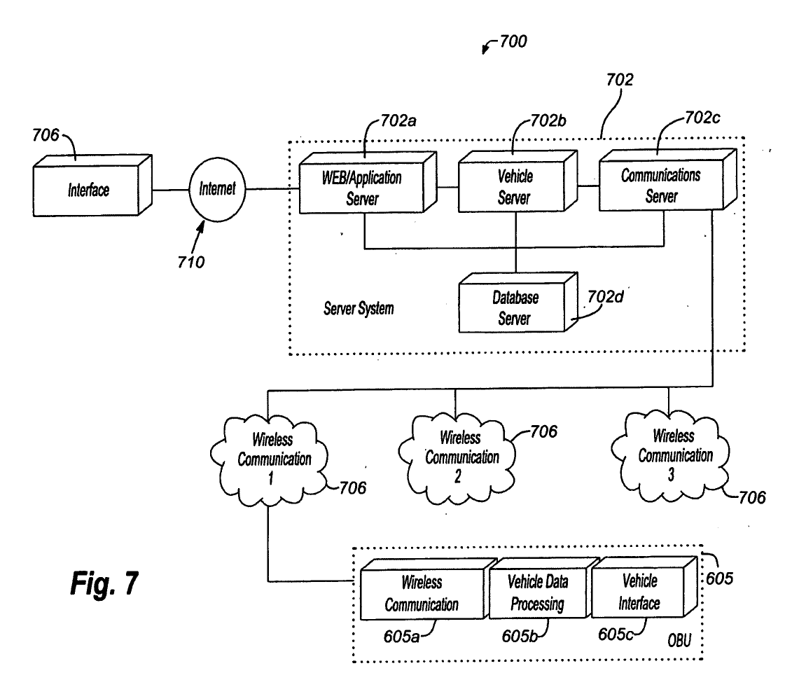

FIG. 7 is a block diagram of system architecture 700 of a telematic, diagnostic and/or prognostic system. The system architecture 700 shown in FIG. 7 is one possible way for carrying out the functionalities described above and shown in FIG. 6. In this example, the architecture includes three primary components: the interface 706, a system server 702, and the onboard unit (OBU) 605. All three components 706, 702, 305 are designed to communicate with each other through any known means, including wireless communication networks 706(1-3).

The interface 706 can be, for example, a user interface and/or a machine interface that allows a human or machine to access the infrastructure 702, which includes the system server 702. The system server 702 may include, for example, a series of servers that perform web page hosting, run applications, perform data storage, and/or perform wireless communications network management. In this example, the system server 702 includes a web/application server 702a, a vehicle server 702b, and a communications server 702c, all of which are linked to a database server 702d. As shown in FIG. 7, the system server 702 acts as a link between a client (e.g., a web-based client) 706 and the OBU 605, allowing user access and control to a vehicle data stream via the Internet 710 or other Internet working system.

To facilitate this, the OBU 605 may be deployed with one or more hardware and software frameworks for (i) accessing and obtaining vehicle data from various vehicle and components thereof, such as the on-board electronics or electronic systems noted above; (ii) generating vehicle data of its own; and/or (iii) providing some or all of the vehicle data to the system server 702. The OBU 605 may also include a wireless communication module 605a to provide a communication link to a wireless network, a vehicle data processing module 605b to process data obtained from the vehicle components, and a vehicle interface 605c connected to, for example, the vehicle data bus to gather vehicle data from the vehicle and/or components thereof for processing and managing time or process-critical functions with the on-board electronics or electronic systems, such as electronic control units. The OBU 605 may also include a global positioning system and a driver display interface.

Each of the system architecture components will be described in greater detail below.

i. Interface

The interface 706 may be a standard browser interface and/or a machine-to-machine interface. In the browser interface, a human user accesses the system via a standard web browser. In one embodiment, the user gains access to the specific set of their authorized vehicles and functions after login and password authorization. In a machine-to-machine interface, server and vehicle data and functions may be accessible via a secure application program interface (API). A machine-to-machine interface allows other applications access to the system's 700 capabilities so they can gain remote access to the vehicle and the capabilities offered by the system. This allows the system 700 to interface with existing or planned back office applications and operations, making the system 700 suitable for integration with, for example, overall fleet operations, the ERP system 300, and/or other systems.

ii. Server and On-Board Unit

The server system 702 is the fixed-based component of the system 700, and as explained above, can be an Internet-based system and use an ASP model. The end user can access the system from the interface 706, such as any commercially available web browser. As noted above, the server system 702 in this embodiment includes the web application server 702a, the communications server 702c, the database server 702d, and the vehicle server 702b. Each of these will be described in greater detail below.

A. Application Server

The web application server 702a contains the logic defining one or more applications to an end user. All the data needed for a specific user application is requested and sent to the OBU 605 via one of the wireless communication networks 706(1-3). As will be explained in greater detail below, applications perform the necessary calculations and then package the results for presentation in a defined format to the user. Further, the web application server 702 is responsible for running business applications related to user activities, which may include performing business logic, interfacing to the systems databases for fleet, vehicle, component, and transaction activity, knowledge-base storage, and sending user requested vehicle queries or functions to the vehicle server 702b and the communications server 702c.

B. Communication Server

As shown in FIG. 7, one embodiment of the inventive system allows communication between at least the vehicles 704 and the server 702 via a wireless network, such as a satellite or terrestrial based network. A communication server 702c may be included in the server 702 to support wireless communications and provide a central location for supporting changes and improvements in wireless technology. In one embodiment, the communication server 702c manages the communications activities between the OBU 605 and the vehicle server 702b and processes vehicle/component specific requests between the OBU 705 and the vehicle server 702b.

In one embodiment, the communications server 702c utilizes a wireless communications framework (WCF) that provides a communication link between the system server 702 and the vehicle 704. Although any wireless mobile communication system can be used in the inventive system 700, a flexible wireless communication infrastructure that is capable of handling multiple platforms and/or multiple communication providers is desired. Details of an exemplary wireless communication framework are described below and in co-pending U.S. patent application Ser. No. ______, filed May 24, 2004, entitled “Wireless Communication Framework” (attorney docket 03078-A1).

To handle multiple communication providers and/or platforms, the flexible wireless communication infrastructure may abstract the needs of a specific wireless communication provider, such as the message size, message format, and specific protocol details, into a standard messaging API understandable by multiple systems and platforms. In one embodiment, the communication server 702c abstracts messages, and stores and forwards messages to ensure later delivery of messages to vehicles that are temporarily outside a wireless communication coverage area, and may even include least cost routing rules to select among multiple wireless networks to prioritize message routing based on cost and/or criticality of the message.

C. Database Server

The system server 702 also includes a database server 702d containing relational data tables designed to retain information pertaining to a user, a vehicle, a fleet, system transaction history and other relationships associated with a given vehicle 704. The database server 702d also may be designed to retain the data resulting from any vehicular transaction, such as transactions between the OBU 605 and the system server 702. In one embodiment, the database is structured such that authorized users can access vehicles in a number of ways, for example, by fleet ownership, leasing fleet, vehicle manufacturer, and component manufacturer. This structure enables the system 700 to provide each of these beneficiaries with specific, customized data and access in a format meaningful to each user.

D. Vehicle Server

The vehicle server 702b provides the fixed-based component of the realtime computing base for the system. It stores and processes vehicle-specific data and acts as a translator between the applications 708, 710 and the specific vehicle and/or vehicle component. More particularly, the vehicle server 702b is responsible for processing data requests and vehicle responses, and for converting the outbound and inbound data into translated vehicle data.

The vehicle server 702b translates user requests from the interface 706 into formats specific to the vehicle 704 to which the request is directed. The vehicle server 702b typically conducts this translation without any user interaction or property selections. For example, the vehicle server 702b may evaluate a message being sent to a particular vehicle and detect the vehicle type, the vehicle bus type, and the vehicle component or sub-component that is intended as the message recipient. The vehicle server 702b then packages the message according to the specific communication protocol mandated by the recipient component. As a result, the vehicle server 702b allows monitoring and control of different vehicles having different components through the same interface 706 for a given user and application.

E. On Board Unit (OBU)

The OBU 605 provides the vehicle-side, real-time computing base for the system. In one embodiment, the OBU 605 is responsible for data stream processing, discrete measurements, vehicle position information, wireless communications, and real-time analysis of data. Within the system's overall framework, the OBU 605 acts as a vehicle server, providing vehicle specific data and functionality. In one embodiment, the OBU 605 may be an expandable custom hardware platform designed and manufactured to reside on a wide variety of vehicles with different component specifications and needs and is preferably capable of running multiple applications while acting as a vehicle data gateway for others.

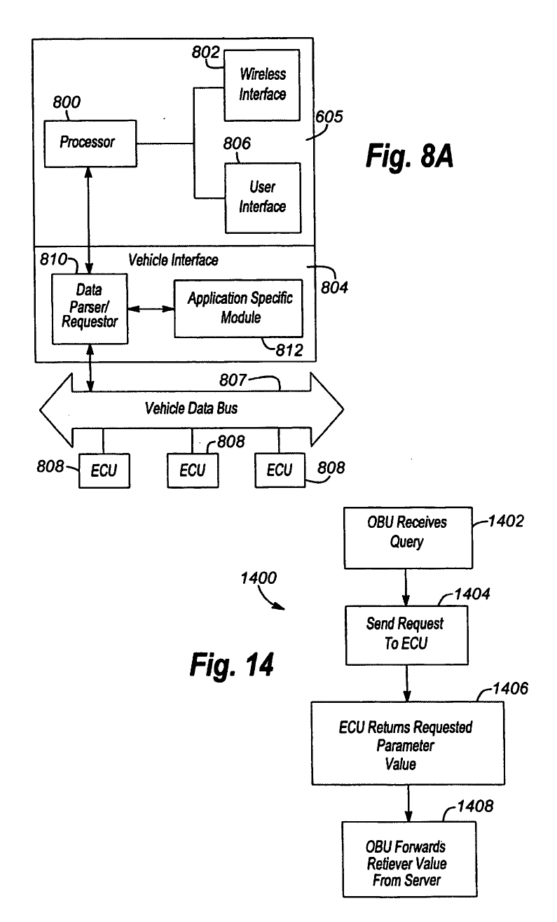

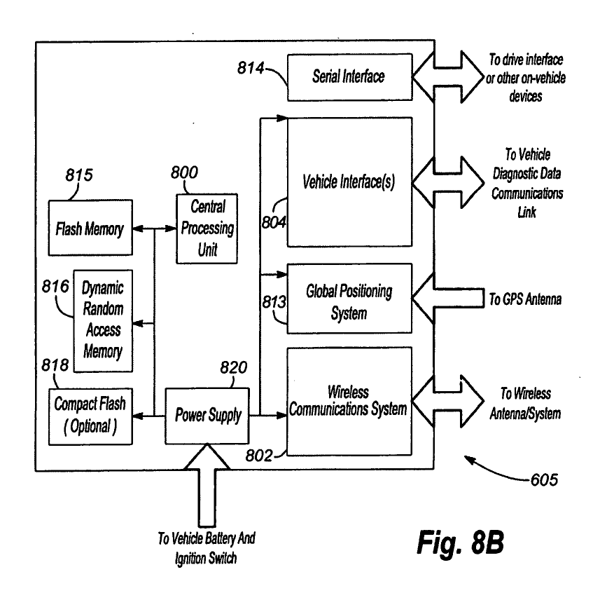

FIGS. 8A and 8B are block diagrams of the OBU 605. One embodiment of the OBU 605 may include a data processor 800 and one or more interfaces 802, 804, and 806. Included among the interfaces is a wireless interface 802 that may control communication between the OBU 605 and the system server 702 via one of the wireless networks 706(1-3), a vehicle interface 804 that allows the OBU 605 to transmit to and receive from on-board electronics or electronic systems, for example, electronic control units (ECUs), vehicle controllers, and/or other vehicle components 808, and an optional user interface 806 that allows a user to read and/or enter information into the OBU 605.

The wireless interface 802 in one embodiment sends and receives data from the system server 702 to and from the OBU 805 and abstracts communication operating parameters from different wireless network devices to allow the OBU 605 to communicate with a flexible wireless communication infrastructure, such as the type described above with respect to the system server 702. More particularly, the wireless interface 702 may encapsulate protocol differences among various wireless network devices to provide a standard output to the processor 800. In one embodiment, wireless network messages are routed from the system server 702 to the wireless interface 702 for error checking and filtering. After filtering, commands are passed to the processor 800 and then routed to their respective vehicle components.

The processor 800 acts as the central processing unit (CPU) of the OBU 605 by managing the sending and receiving of requests between the system server 702 and the vehicle 704 via the wireless interface 702. In one embodiment, the processor 800 has the logic and intelligence to carry out vehicle specific services such as diagnostic requests and processing. For example, the processor 800 may run specific applications that are loaded into the OBU's memory 815, 816, 818 (FIG. 8B) and coordinates activities between the vehicle datastream, GPS unit 813 (FIG. 8B), wireless communications 802, and the system server 702. Further, in one embodiment, the processor 800 can be updated through the one of the wireless networks 706(1-3) to add and enhance its functionality. This capability eliminates requiring the vehicle to be at the service bay for software updates that enhance features and functionality.

The vehicle interface 804 allows the OBU 605 to support a wide variety of vehicle components and subcomponents. Possible interfaces that can be supported by the OBU include SAE J1708, SAE J1939, SAE OBDII/CAN, ISO-9141, discrete I/O, proprietary interfaces, and other interfaces (e.g., discrete or instrumentation interfaces). Further, the vehicle interface 804 provides a single point of contact for all vehicle components and control devices on the vehicle 604, allowing the communication between OBU software with the vehicle's actual data bus line as well as wireless communication devices, such as a satellite-based communications system.

In one embodiment, the vehicle interface 804 may include a data parser/requester module 810 that contains software code logic that is also responsible for handling direct interfacing between the processor 800 and the vehicle data bus 807 for non-application specific (i.e., “generic” SAE J1708 or SAE1939 discrete measurement points) parameter readings, alerts, configuration or reprogramming data.

The vehicle interface 804 may also include, for example, one or more application specific modules 812, such as one for each manufacturer specific controller 808 within the vehicle 604, each containing software code logic that is responsible for handling interfacing between the processor 800 and the vehicle data bus 807 (via data parser/requestor module 810 in this example) for application/specific parameter readings, alerts, configuration or reprogramming data.

Note that the OBU 605 may act as a server and/or data gateway for an application that places data directly on the vehicle data bus 807. In one embodiment, the OBU 605 uses an interface standard, such as TMC RP 1210A, as an element of the data gateway. Regardless of the specific standard used, any activity using the OBU 805 as a data gateway will involve data going through the processor 800.

In an embodiment of the present invention, the OBU 605 is designed to be compliant with the SAE's Joint SAE/TMC Recommended Environmental Practices for Electronic Equipment Design (Heavy-Duty Trucks), Document No. J1455 (August 1994) standard, which is incorporated herein by reference in its entirety, because it will be a component included (or installed) within vehicles 104. As indicated above, the OBU 805 is not limited to be compliant with any particular standard and can accommodate any on-board electronic system standard (e.g., SAE J1708, SAE J1939, SAE J1850, ISO 9141, proprietary data streams, etc.) for any sub-system (e.g., engines, transmissions, braking systems, instrument clusters, etc.) as long as the system 800 is capable of converting commands between the interface 606 and the OBU 605 according to whatever standard is used by a given vehicle electronic system. If the vehicle electronic system uses a proprietary standard, for example, then the vehicle server 702b and the associated application specific module 812 on the OBU 605 may be adapted to accommodate the proprietary standard.

FIG. 8B illustrates another embodiment of the OBU 605 and shows the capability to interface with other devices via, for example, a parallel interface, serial interface, universal serial bus (USB), satellite, terrestrial wireless (e.g., 802.11b), and/or a global positioning system (GPS). More particularly, the embodiment of the OBU 605 shown in FIG. 8B includes a GPS circuit 812 that receives signals from a GPS antenna and a serial interface 814 that communicates with a driver interface or other on-vehicle devices (not shown), such as a handheld device, a cellular telephone, voice messaging system, data logger, or other devices. FIG. 8B also illustrates a flash memory 815, a dynamic random access memory 816, and an optional compact flash memory 818 coupled to the processor 800 as well as a power supply 820 coupled to the vehicle battery and ignition switch (not shown). Those of skill in the art will understand that the elements and concepts shown in FIGS. 8A and 8B can be combined in any manner without departing from the scope of the present embodiment.

The application software and the application framework are built with both a software and hardware abstraction layer, such as the xVDS framework 306 noted above. This approach makes the framework adaptable to a number of alternative operating system and hardware platforms. One embodiment of the OBU 605 may use any known real-time operating system.

iii. Communication Networks

Referring back to FIG. 7, the server system 702 and OBU 605 can communicate via one or more communication networks. Each of the communication networks may be a partial or full deployment of most any communication or computer network, and thus, can include a few or many network elements, most of which are not shown. Each communication network may include circuit-switched as well as packet-data elements to provide transport of at least data communications between server system 702 and OBU 605. It can be public or private, terrestrial wireless or satellite, and/or wireline, such as the wireless communication networks 706 (exemplified by wireless communication networks 706(1-3).

Public wired and/or wireless networks typically provide telecommunications and other networking services in a particular geographic coverage area to its subscribers. And generally, any interested member of the public meeting minimal criteria may become a subscriber of public network. In the case of wireless or satellite networks, public networks typically provide coverage to other wireless networks” subscribers who are roaming within the coverage area of network as well.

Additionally, the coverage area of public network is typically wide-ranging. For example, the coverage area of a wireless public network may encompass a metropolitan area, a substantial part of a metropolitan area, numerous metropolitan areas, or an entire nation or region. When integrated with public wired and satellite networks, the combined networks provide national along with international coverage. Thus, each of the wireless communication systems 706(1-3) may include portions of a Public Switch Telephone Network (PSTN), the Internet, core and proprietary public networks, and/or wireless voice and packet-data networks (e.g., 1G, 2G, 2.5G and 3G telecommunication networks).

Each communication network may be a private or “enterprise” wired or wireless network as well. Unlike public networks, private networks advantageously provide the enterprise with greater control over the network, which in turn allows vast customization of the services (e.g., localized abbreviated dialing) provided to the network's users and/or subscribers.

These networks are “private” in that the networks” coverage areas are more geographically limited. Typically, but not necessarily, subscription to such private networks is limited to a select group of subscribers. Networks deployed by many enterprises that only allow their employees, customers, vendors, and suppliers to subscribe exemplify these private networks.

Many enterprises, Small Office/Home Office (SOHO) entities, and private individuals have private-wireline-switching systems. These private-wireline-switching systems may include, for example, private branch exchanges (PBXs) and/or media gateways. The private-wireline-switching systems switch, couple or otherwise connect communications (i) internally, i.e., among the subscribers of the network and (ii) externally, i.e., between the subscribers of the private network and subscribers of public networks.

In addition to the wireline networks, enterprises, SOHOs and private individuals are increasingly deploying private wireless communication systems, such as wireless office telephone systems (“WOTS”) and/or wireless local area networks (WLANs), e.g., Bluetooth and/or IEEE 802.11 WLANs, in lieu of or in addition to wireline switching systems. Similar to public networks, private networks may be integral to or integrated with other private and public satellite, terrestrial wireless, and wireline networks to provide national and international coverage.

Accordingly, each of the wireless communication networks 706(1-3) can be any of a private and/or public terrestrial, satellite and/or other wireless network. And each of the wireless communication networks 706(1-3) can be incorporated into a wide-area network (WAN), thereby creating a Wireless WAN (WWAN); a local area network (LAN), thereby creating Wireless LAN (WLAN); and/or other wired network. Alternatively, each of wireless communication networks can be a standalone WLAN.

At times, a single wireless service or technology may not provide a desirable messaging cost structure or geographical coverage to support all the features and users of the system 600 (FIG. 6). Multiple services might be used instead to provide for dynamic balancing between messaging costs and message timeliness. In addition, different wireless services and technologies may have different application program interfaces (APIs) and/or require custom interfaces for given computing environments. Moreover, messaging capabilities may differ across different services and technologies.

iv. Wireless Communication Framework

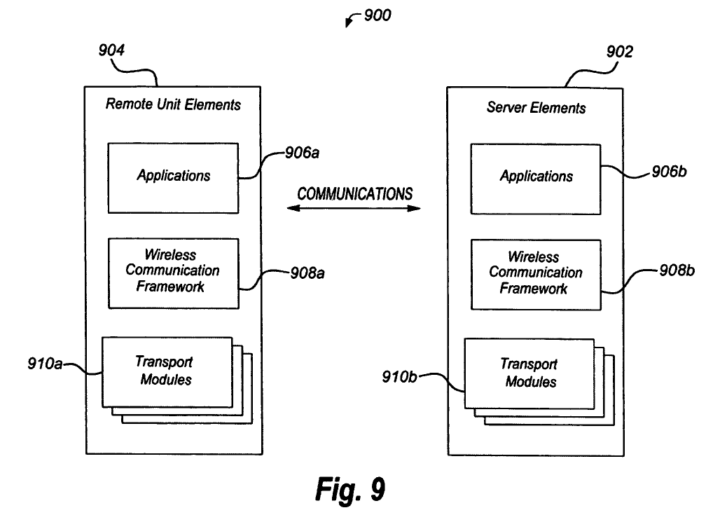

FIG. 9 illustrates exemplary architecture 900 of the wireless communication framework (WCF) in accordance with an exemplary embodiment. The WCF may encompass a number of software and/or hardware program and/or application elements for carrying our wireless communications between two wireless nodes.

The WCF architecture may be concentrated on either the server system 702 or a remote unit that is operable to communicate with the server system 702, such as the OBU 605. In such case, the device having server portions of the WCF architecture may act as a server in a client/server relationship and the device having the client portions may act as the client. Because the server and client responsibilities may change depending on the function to be carried out, the server system 702 can be a server for one function, yet a client for another. Similarly, the remote unit may be a client for one function, and a server for another.

Alternatively, the WCF may be distributed among one or more server-system elements 902 and one or more remote-unit elements 904. In a distributed embodiment, the remote-unit elements 904 may be included within a remote unit, such as the OBU 605, and the server-system elements 902 may be deployed in the server system 902.

In addition to the OBU 605, it is understood that the remote unit may a Personal Digital Assistant (PDA) and/or another computer that can be communicatively coupled with server-side elements 902. As such, the remote unit may contain server-system elements 902 in addition to or in lieu of the remote-unit elements 904, thereby enabling communications between itself, the server-system 702 and/or another remote unit, such as another OBU (not shown).

The remote-unit elements 904 may include (i) remote-unit application programs 906a (e.g., full or partial application programs that reside on the remote unit) such as those as described above, (ii) remote-unit transport modules 910a, and (iii) one or more intermediary remote-unit WCF modules 908a.

Similarly, the server-system elements 902 may include (i) server-system application programs 906b, which may or may not be counterparts to the remote-unit application programs 906a; (ii) server-system transport modules 910b, and (iii) one or more server-system WCF modules 908b, which may or may not be the same as the remote-unit WCF modules 908a.

With reference to FIG. 9, the transport modules 910a, 910b, alone or as a complementary pair, may be deployed as one or more different software programs, software modules, and/or hardware modules for connecting and interacting with various communication networks, such as the wireless communication networks 706(1-3). The transport modules 910a, 910b provide one or more interfaces through which the application programs 906a, 906b couple to the WCF modules 908a, 908b.

In doing so, each of the transport modules 910a, 910b may be configured to (i) execute protocols to access its corresponding communication network, (ii) initialize, maintain, and shut down server-system and/or remote unit communication adapters (e.g., modems), respectively, (iii) test the server-system and/or remote unit communication adapters, and/or (iv) perform any other functions and/or procedures to carry out communications with the corresponding communication network for which the particular transport module 910a or 910b is associated.

Each of transport modules 910a, 910b may be tailored (e.g., abstracted or otherwise configured) for access to a specific implementation and/or format of a communication network. If, for example, each of the wireless communication networks 706(1-3) are different from each other, then a first of the transport modules 910a, 910b may be configured to access wireless communication network 706(1), a second may be configured to access wireless communication network 906(2), a third may be configured to access wireless communication network 706(3), and so on. Other transport modules 910a, 910b can be included to access additional network services, such as those provided by WLANs or WWANs.

The number of transport modules 910a, 910b deployed in the remote-unit and/or server-system elements 902, 904 may be a function of the number, configuration and/or format of the communication networks 706(1-3) that the server-system 702 and/or the remote unit may have access to. For instance, the remote unit might not need to have access to the Internet. And thus, having a transport module 910a for Internet access may be omitted. On the other hand, the server-system elements 902 may have access to a host of networks that the remote unit elements 904 do not. Accordingly, the server-system elements 902 may have transport modules 910b configured to carry out communication with these networks.

If, for example, remote-unit elements 902 are deployed in a number of remote units in a fleet of vehicles that travel in a specific geographical region where access is available to wireless communication networks 706(1), 706(2), but not wireless communication network 706(3), then the remote-unit transport modules 910a may be configured to access the wireless communication networks 706(1), 706(2).

The server-system elements 904, which may or may not be co-located in the same specific geographical region as the remote units, may have access to the wireless communication network 706(3) (e.g., a WLAN) in addition to the other communication networks. Thus, the server-system transport modules 910b may be configured to access wireless communication network 706(3) as well.

Thus, the server-system elements 904 may have access to a host of networks to communicate with each of the remote unit elements 902, even though not all of the remote unit elements 902 have the corresponding access. For instance, one of the remote unit elements 902 may have access to only network 906(1), while another of the remote unit elements 902 may have access to only network 706(2), but the server system elements 904 may have the transport modules 910a, 910b to support both networks 706(1-2).

Moreover, the number of transport modules 910a, 910b may be a function of the monetary and overhead costs of subscribing to multiple communication networks. For instance, the number of transport modules 910a, 910b may be limited when monetary cost savings (e.g., discounted delivery rates) in using more networks cannot be justified. Other non-monetary costs, such as memory usage and processing losses, may also limit the number of transport modules 910a, 910b.

Conversely, the number of transport modules 910a, 910b may be greater when non-monetary and monetary cost savings can be obtained by the use multiple networks. These cost savings may be embodied as discounted rates, which can be apportioned by time, volume of calls; time of day, month, etc; geographical region; and other metrics.

(b) Wireless Communication Framework Modules

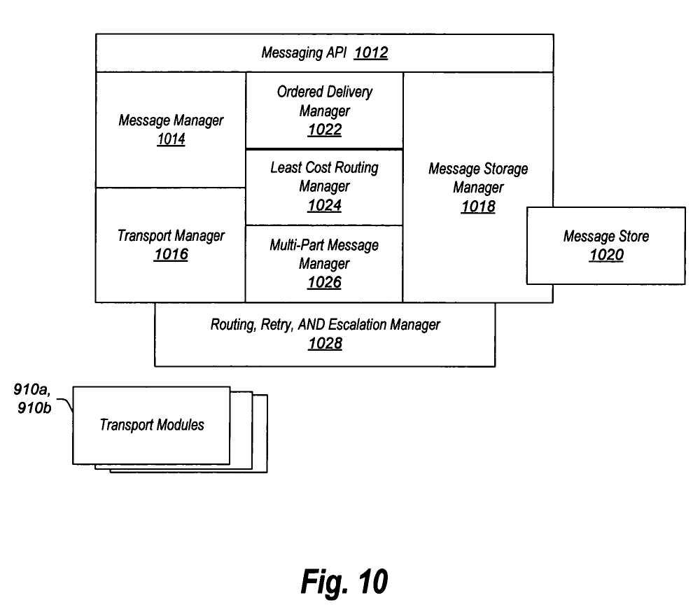

FIG. 10 illustrates the WCF modules 908a, 908b in greater detail. The WCF modules 908a, 908b may be deployed with a messaging Application Program Interface (messaging API) 1012, a message manager 1014, a transport manager 1016, message-storage manager 1018, a message store 1020, ordered delivery manager 1022, a least-cost routing manager 1024, a multi-part message manager 1026, and a routing, retry and escalation manager (RREM) 1028.

Regardless of whether the WCF is distributed among or concentrated on a remote unit and/or server system 702, some or all of the functions of WCF modules 908a, 908b may be deployed in both the remote-unit and server-system elements 902, 904. In the case of a concentrated system, however, function calls may be used to establish communication between the concentrated elements.

In some instances, the remote-unit WCF module 908a might not perform the same functions that are carried out by the server-system module 908b, but rather it may perform functions that complement and/or accompany functions carried out by the server-system elements 908b. Similarly, the server-system WCF module 908b might not perform the functions that are carried out by the remote-unit module 908a, but rather functions that complement and/or accompany functions carried out by the remote-unit elements 908a. Further, some of the functions of the WCF modules 908a, 908b may be applicable to only a remote unit or server system 702. Thus, some of the functions carried out by WCF modules 908a, 908b may only exist in either the remote unit or server-system elements 902, 904. Further detail of the wireless communication framework modules 908a, 908b is provided below.

i. Messaging API

The messaging API 1012 may provide the functionality to receive, send, and process messages sent to or coming from multiple application programs. This functionality can be carried out by the messaging API 1012 even if the application programs 906a, 906b use program and data structures different from rest of the WCF architecture.

As such, the messaging API 1012 may allow many different application programs to use a common and/or “standardized” messaging format provided by the WCF modules 908a, 908b. This beneficially allows the development of application programs without the need for custom or tailored programming. For instance, the WCF architecture and the messaging API 1012 may provide the messaging system, bridge (gateway, and/or conduit), storage, and programming that allow an application program to be developed and implemented independent of the communication network used by the WCF architecture.

In facilitating such application development independence, the messaging API 1012 may abstract the differences between transport providers (e.g., the providers of wireless communication networks 706(1-3)) and the differing technologies of the wireless communication networks to allow applications to be written independently of the services and transport providers selected. Accordingly, when a new application program is to be added, the messaging API 1012 may provide hooks or other access interfaces to the application programs to achieve communication without substantial custom programming.

ii. Message Manager

The message manger 1014 may manage the delivery and acceptance of messages to and from the application programs 906a, 906b. The message manager 1014 may also manage a reliable delivery function that insures messages are not dropped or lost. The reliable-message delivery performed by the message manager 1014 may be accomplished using message-delivery verification, which will be discussed in greater detail below.

iii. Transport Manager

The transport manager 1016 manages the selection of transport modules 910a, 910b available to the remote unit and/or server system elements 902, 904. The transport manager 1016 may work in conjunction with other components of the WCF modules 908a, 908b, such as the least-cost routing manager 1024 (discussed below) for determining which of the transport modules 910a, 910b to select.

iv. Ordered Delivery Manager

The ordered delivery manager 1018 manages an ordered delivery of messages sent by any of the application programs 906a, 906b. Ordered delivery may be any predefined order in which messages are to be sent, and can be configured as an ordered delivery service. This provides a significant advantage when performing database edits or other information that is order dependent.

When ordered delivery is desired or requested by any of the application programs 906a, 906b, the order delivery manager 1018 may arrange the messages in any of the plurality of predefined orderings irrespective of when the WCF modules 908a, 908b receive the messages from the application programs 906a, 906b. Under the WCF messaging system, messages can be configured to specify a given delivery queue using, for example, a queue identifier or other notation. Under this scheme, messages with a given queue identifier may be sent to a particular queue, as indicated by the queue identifier. Before transmission, the messages may be arranged in the particular ordering selected.

v. Least-Cost-Routing Manager

The least-cost-routing manager 1024 may be responsible for selecting one or more of the transport modules 910a, 910b based on a plurality of factors, such as the cost and timeliness of message delivery. This WCF module may be expanded using custom routing factors as desired.

In addition to cooperating with other WCF modules 908a, 908b, the least-cost-routing manager 1024 may operate in combination with the transport manager 1016 to determine which of the transport modules 910a, 910b to select. The least-cost routing manger 1024 may, for example, link or relay information to the transport manager 1016 after determining the low cost provider so that the messages may be transmitted via the low cost service provider.

vi. Multi-Part Message Manager

The multi-part message manager 1026 may manage disassembly (and reassembly of previous disassembly) of large messages for transport among the server system 702 and any of the remote units. This is particularly advantageous when the message to be sent exceeds the maximum allowable message size for the selected one of the networks 706(1-3). The multi-part message manager 1026 may be invoked to ensure that the message adheres to the set maximum message size by disassembling the message into groups of smaller chunks.

The chunk size may be, for example, 16 or 32 byte chunks. Chunk size selection may also depend upon the maximum allowable size message that can be sent over the selected one of the wireless communication networks 706(1-3) without degradation or loss of the contents of the message. The chunk size may be based upon satisfactory transmission accuracy returned from error-control algorithms, for instance. The multi-part manager 1026 may be equipped with intelligence, e.g., dynamic and/or statistical algorithms, for selecting a proper chunk size for maximizing throughput, bandwidth and/or other transmission parameter.

The following describes, by way of a simple, non-limiting example, of how the multi-part manager handles such overage. Assume for this example that the wireless communication networks 706(1) may have a maximum allowable message size of about 100 bytes per message, and the network 706(2) may have an allowable message size of about 512 bytes per message. In either case, however, a certain number of bytes per chunk, e.g., 2 bytes, may be allocated to overhead, reducing the number of available bytes for transmission of content over wireless communication networks 706(1-3).

Assume for this example that a message having content equaling about 100 bytes is destined for transmission across the wireless communication networks 706(1). Since the content of the message exceeds the 100 byte maximum allowable message size, the multi part message manager 1026 can disassemble the message into the smaller 16 and/or 32 byte chunks.

If, for example, the 16 byte chunk is selected, the chunk size dictates that the message will be first broken down into five 16-byte chunks, totaling 80 bytes (16×5=80)+10 bytes overhead. At this chunk size, another 16 byte chunk cannot be sent because the sixth 16-byte chunk causes the accumulated byte size to equal 106 bytes (plus 2 bytes overhead), thereby exceeding the maximum allowable message size of 100 bytes by 8 bytes. The multi-part message manager 1026 can reassemble the five chunks into a first-part message, leaving the 10 remaining bytes (100−90) for a second-part message, which may be have other content added to optimize available bandwidth. In such case, the first-part message will only have 10 unused bytes.

If, on the other hand, the larger 32 byte chunk size was selected, then the chuck size dictates that the first-part message will be broken down into only two chunks (2×32=64)+4 bytes overhead. A third chunk will cause the accumulated byte size to exceed the maximum allowable message size of 100 bytes by 2 bytes ((3×32)+(3×2)=102). Consequently, the first-part message would have 32 bytes of unused space, which is 22 bytes more than when using the 16 byte chunk size. Accordingly, the smaller chunk size allows more of the available message size to be utilized.

The added number of smaller chunks, however, may cause more chunks to be sent. This may increase the amount of overhead, which may accumulate as a function of the number of chunks. With smaller message sizes, not many chunks need to be sent. In some circumstances, an optimization penalty resulting from overhead incurred when sending a smaller message with smaller chunks might not outweigh the reduction of unused bytes accomplished with the smaller chunk size.

When using the second wireless communication networks 706(2), for example, the multi-part message manager 1026 may more optimally disassemble the message using the larger 32 byte chunks. As noted, the increased number of chunks required to be sent to accommodate the 1012 byte size message increases the amount of corresponding overhead needed to send the message. Such an increase may fail to outweigh the reduction of unused bytes that accompanies the use of smaller chunks. As is apparent, larger chunk size may be beneficial for larger message sizes, the smaller chunk size may be more beneficial for smaller available message sizes. As such, a programmer or user of the WCF can flexibly pick a predetermined maximum byte size limit of a network at which the multi-part message manager 1026 will disassemble a message into smaller or larger chunk sizes. The user, for example, could select a prescribed threshold of 200 bytes, which may allow a message to be disassembled into smaller chunks only when the maximum allowable limits falls below this threshold. Messages otherwise may be disassembled into larger chunks when the maximum allowable limits rises above this level.

The multi-part message manager 1026 can also break messages into chunks for other reasons than to accommodate large messages. For instance, the chunk size may be set to a size slightly smaller than the maximum allowable byte size of the wireless communication networks 706(1-3) regardless of actual message size. With this alternative and with smaller chunk sizes in general, the probability that a message will get through a network without unacceptable retry attempts increases.

Additionally, the multi-part message manager 1026 might not need to re-send already-acknowledged message chunks even if a partially complete message is re-routed through another network (e.g., from network 706(1) to network 706(2)). Accordingly the chunk size may be changed to another size based on which networks are available. If, for example, the message is rerouted from a network 706(2) to network 706(1), the chunk size may change from 32 bytes to 16 bytes. However, the chunk size in one network may be compatible with another, and thus, need not to be changed. Other variations on the size of the chunk in relation to the network may be utilized as well.

vii. Routing, Retry and Escalation Manager

The Routing, Retry, and Escalation Manager (RREM) 1028 has the responsibility for choosing the wireless communication networks 706(1-3) over which one or more messages may be sent. The RREM 1028 is a customizable component that can be tailored to the system 600 and/or application programs 906a, 906b for which the WCF is being used. The RREM 1028 may implement a routing algorithm that may be a lot more sophisticated than a least cost routing algorithm, which sends the message on the cheapest available network.

The RREM 1028 can also make decisions based on a message priority assigned by the application programs 906a, 906b, and on the size or other properties of the message. The RREM 1028 may send a high priority (e.g. emergency) message simultaneously on all of the available wireless communication networks 706(1-3) to have the best possible chance of getting the message through quickly.

The RREM 1028 may also manage the messaging behavior over a particular one of the wireless communication networks 706(1-3) according to both the particular rules of the particular network and the needs of the application programs 906a, 906b. For example, a satellite network provider might want to avoid network saturation if a user action causes a message to be sent to many vehicles. In such case, the RREM 1028 may determine that a message has low priority, and responsively space out the time at which such messages can be sent to avoid saturation.

To facilitate the disposition of messages, the RREM 1028 may carry out the following. The RREM 1028 may queue each message for delivery over one or more of the wireless communication networks 706(1-3). The messages may be queued for transport over multiple transports simultaneously. For example, messages may be queued for both wireless communication network 706(1), which may be embodied as a WLAN, and wireless communication network 706(2), which may be embodied as a Public CDMA wireless network. Given that a message queued for transmission over the wireless communication network 706(2) may not even be sent immediately (e.g., due to message window and network throttle considerations as described in more detail below), the message could be simultaneously queued for transport over the wireless communication network 706(1). If the message is successfully sent over wireless communication network 706(1), it can be removed from the queue for the wireless communication network 706(2). The RREM 1028 may establish a transport-specific priority level with which messages are queued.

The RREM 1028 may escalate messages from one of the wireless communication network 706(1-3) to another. Such escalation may be based on network-specific timeouts and application-program 906a, 906b specific rules. The RREM 1028 may determine timeout values for each message, and may fail a message if certain conditions are met. A message might be deemed failed if it could not be sent within a certain time period or number of retries. With Ordered Delivery, messages might not be failed, but rather replaced as described above to avoid creating holes in the ordered delivery sequence numbering. An alternative to failing a message might be to log a system alert that a message could not be delivered.

The RREM 1028 may implement application-specific rules. This allows the system designer (using the WCF) to establish their own rules for routing, retry, and escalation based on the needs of the system 100. The RREM 1028 might require some knowledge of the specific transports in use by the system.

The RREM 1028 might not interface directly with the Message Storage Manager 1018. Instead, it may receive notifications of significant events and be expected to take action based on the event. Such events may include (i) a new outbound message that has been queued and requires disposition by the RREM 1028; (ii) a message previously queued by the RREM 1028 for transmission that has been successfully sent on one or more of the wireless communication networks 706(1-3); and/or (iii) a message previously handled by the RREM 1028 that has reached an escalation or timeout time.

When receiving a notification of the event regarding a message previously queued by the RREM 1028 for transmission that has been successfully sent on one of the wireless communication networks 706(1-3), the RREM 1028 may (i) update the timeout time for the message to reflect the time the message was sent, (ii) modify or remove the message's escalation time; (iii) remove the message from other queues; and/or (iv) treat it in some other way.

When receiving a notification of the event regarding a message previously dispositioned by the RREM 1028 has reached an escalation or timeout time, the RREM 1028 may re-queue the message on the same or a different one of wireless communication networks 706(1-3), remove the message from other queues for the other wireless communication networks 706(1-3); and/or treat it in some other way.

viii. Message Storage Manager

The message-storage manager 1018 may be responsible for keeping a queue of messages that are waiting to be sent, have been sent or are awaiting an acknowledgement. In the former case, the message-storage manager 1018 may operate in conjunction with other WCF modules 908a, 908b to maintain the message in the queue until one of the transport module 910a, 910b connects to the chosen network.

In the latter case, the message-storage manager 1018 may maintain a record (e.g., a table) of sent messages. This record may be used to ensure reliable delivery of the message in case of a failure of system 100, an out-of-coverage area error, and/or other error. With the record, a message is able to be resent from the message store 1020 in response to such a failure.

At the receiving end, the message-storage manager 1018 may also maintain a copy of the message as a handshaking mechanism. This copy may be maintained until the message is successfully delivered to the target application. If, for example, the server system 702 sends to OBU 605 a message when the vehicle 604 is outside the coverage area of any of the networks 706(1-3), then the message-storage manager 1018 may store the message in the message store 1020. After the vehicle 704 enters the coverage area of one or more of the networks 706(1-3), the message may then be sent.

If the multipart message manager 1026 has disassembled the message into chunks, then the chunks already sent may be stored at the message store 1020 of the OBU 605, and the chunks not sent may be maintained at the server system 702. This beneficially prevents unnecessary and costly retransmission of already sent chunks in the case of, for example, system failure, out-of-coverage area errors or other connectivity failure. Such benefit may be realized because only the chunks maintained in the message store 1020 of the server system 702 are sent to the OBU 605. Since the chunks that have been already sent may be maintained in the message store 1020 of the OBU 605, the message can be reassembled using the earlier stored chunks and the chunks sent after reconnection.

ix. Message Services, WCF Extensibility, and WCF Portability

The WCF may also carry out certain message services such as encryption, compression and packaging. The WCF may use standard as well as custom encryption algorithms and cryptography over the entire communication route. Different types of encryption services may be used over different segments of the communication route. The encryption services may be used in addition to or in lieu of any encryption provided by the network service providers. Conversely, the WCF may use the encryption services provided by the network service providers in lieu of the services provided by the WCF.

To limit bandwidth that is required for transmission, messages can be compressed using standard and custom compression algorithms. Different types of compression services may be used over different segments of the communication route. The compression services may be used in addition to or in lieu of any compression provided by the network service providers. Alternatively, the WCF may use the compression services provided by the network service providers in lieu of the services provided by the WCF.

As noted, the WCF may carry out packaging, which allows one or more messages to be packed together to reduce the cost of transmission over transports that support large message sizes. Thus, instead of incurring the overhead and/or acknowledgement costs for each message, these costs may be incurred only once for several messages.

The WCF may be extended in various ways so as to provide extension interfaces that allow the system and/or application designer to customize and extend the WCF for the particular computing platform capabilities and behavior. Included in the extension capabilities are message store, transport modules, least-cost-routing manager, compression, and encryption extensions.

The message store 1020 provides the storage for messaging functions, including message persistence in which messages are maintained message information over a system or component reset, reliable message delivery, order delivery processing, and multi-part messaging. The message store 1020 may be customized according to platform capabilities and system requirements.

In addition to customizing the message store 1020, new transport modules 910a, 910b may be added to support additional communication services and providers. The least-cost routing manager 1024 may be customized to provide sophisticated routing and escalation logic.

As new standards and protocols are developed for message compression and encryption, the WCF may be extended to incorporate the changes. New compression and encryption modules may be used to support non-standard and proprietary protocols.

In addition to being extensible, the WCF may be ported to between platforms and systems. In one exemplary embodiment, an operating-system-thin layer isolates the WCF from operating system differences, thereby allowing portability between platforms. The message store 1020 may abstract the file system, memory structures, and/or database structures in which messages are stored. The WCF may be deployed as dynamic-link libraries or shared libraries on platforms that support such libraries. Alternatively, the WCF may be deployed as static-linked libraries on platforms that support such libraries. The WCF may make use of Computer Object Model (COM) and can be integrated with COM+ on a Windows 2000 platform. As such, the WCF may use the transactional and security features of COM+.

For instance, the WCF may include a security layer (not shown) that institutes a new combination of a number of security elements, such as the elements of IPSec and SSL, for application to a WCF packet. The WCF packet may have a WCF-header part and a WCF-payload part. The WCF packet may contain multiple messages; and thus, each internal message may have a header part and payload part separate from the WCF-header and WCF-payload parts.

In the WCF packet, the WCF-header part may contain clear, but signed text, so as to prevent undesirable spoofing by sending a fake header. The WCF-payload part, however, may be in cipher text form to protect the internal parts of that WCF message. Each individual message within the WCF payload may also follow the same schema. The amount of protection may be adjusted to meet bandwidth conditions.

This security mechanism takes into account an authentication mechanism, which involves a public key infrastructure such as a PKI transaction, to establish the cipher key, but the keeps the key valid over an extended period of time rather than having to reestablish it each time you reestablished connection.

What that means for WCF is that this security mechanism is independent of particular protocols, security and compression could be done at the WCF packet level, and, therefore, not dependent on the messaging protocols of the wireless communication networks 706(1-3).

x. Reliable Message Delivery

As noted, the WCF modules 908a, 908b may bridge or provide a gateway between the application programs 906a, 906b and the transport modules 910a, 910b. In an exemplary embodiment, the WCF modules 908a, 908b can bridge or otherwise couple the remote-unit application programs 904a with the server-system application programs 904b, the transport modules 910a, 910b using standardized and/or proprietary messaging system.

As noted, the API 1012 may manage the acceptance of messages from remote-unit application program 906a and the delivery of messages to server-system application programs 906b. The message manager 1014 may also manage a process for carrying out a function for ensuring that messages are reliably delivered (i.e., reliable-message delivery). The reliable-message delivery may include the process for verifying that a sent message was properly received (hereinafter “message-delivery verification”). The response time and deployment of message-delivery verification can be based on the urgency of the message, for example.

xi. Exemplary Message Dispatch

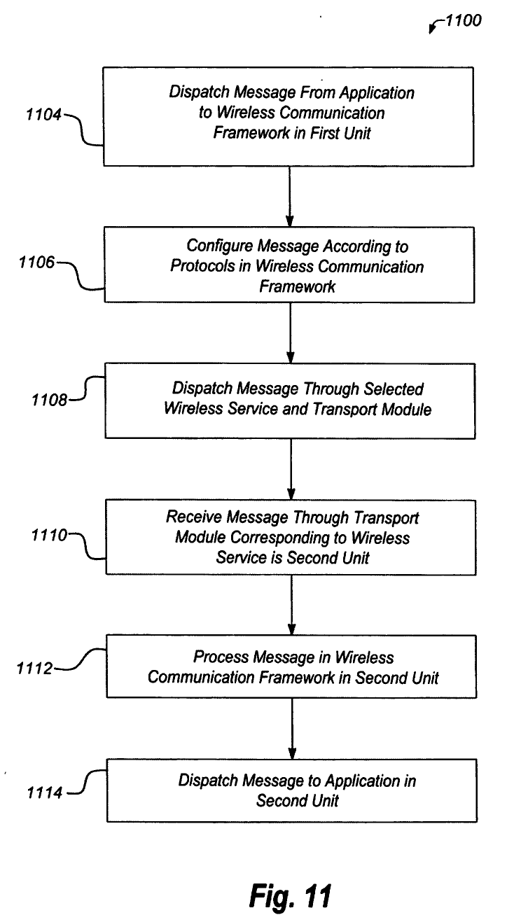

FIG. 11 illustrates a flow chart depicting a communication flow 110 between the service server 702 and the OBU 605. The following describes the flow 1100 of one or more messages originating from the system server 702 and terminating at the OBU 805. The flow 1100, however, may also be carried out in the reverse direction, i.e., originating from the OBU 605 and terminating at the system server 702. Moreover, other devices besides the server system 702 and the OBU 605 may carry out the following flow 1100.

In block 1104, one or more of the messages is dispatched to the WCF from one of the application programs 906a. This dispatch may be carried out via messaging API 1012. As noted, the messaging API 1012 can receive and process messages coming from one or more application programs 906a, 906b. Since the messaging API 1012 can select and provide a corresponding interface for the one or more of the transport modules 910a, the applications 906a can be written to communicate with the messaging API 1012, thereby allowing a programmer to focus on the vehicle application at hand and not the code for carrying out communications over the wireless communication networks 706(1-3).

In block 1106, the messages are configured and formatted for dispatch. The desired transport module 910b that corresponds to the selected one of the wireless communication networks 706(1-3) may be selected. The selection may be based on many factors, such as those described hereinafter. The process of selecting one or more of the transport modules 910b (and in the reverse direction, transport modules 910a) may include reviewing and/or determining network services that are available to the OBU 605. The server system 202 may contain a library of the network services available to one or more of the remote units, such as OBU 605, to assist in the selection of the desired transport module 910b. After determining the available network services, the WCF architecture can proceed to select one or more of the available transport modules 910b for each available network 706(1-3). Other factors, such as cost or transmission speed, may be likewise included in making the determination.

In block 1108, the messages are dispatched through the selected transport module 910b for the desired wireless communication networks 706(1-3). In block 1110, the messages are received by the OBU 1105 via one of the transport modules 910a that corresponds with the wireless service selected by the server system 202.

In block 1112, the messages are processed by the WCF architecture of the OBU 605. This may include the multi-part message manager 1026 reassembling messages that may have been disassembled by the server-system elements 904 of multi-part message manager 1026. Also, the message storage manager 1018 or message manager 1014 may store the messages in the message store 1020 for later processing. The WCF architecture may also perform other desired processing, as noted above, including formatting the messages for delivery to and receipt by one or more of the application programs 906b. Since many application programs 906b may be run simultaneously or concurrently in the OBU 605, the WCF architecture and functionality has the ability to format the messages to suit a number of different possible application programs 906b. Such formatting may be accomplished through the messaging API 1012.

In block 1114, the messages are sent to one or more of the application programs 906b via the messaging API 1012. As noted in block 1106 described above, the message manager 1014 may be used to provide reliable-message delivery. To facilitate the reliable-message delivery, the messages may be assigned a delivery option by one or more of the application programs 906b. This delivery option may be either unreliable or reliable status. If unreliable status is applied to one or more of the messages, then the message manager 1013 may cause the message to be delivered without requiring the OBU 605 to return a confirmation acknowledgement or receipt. In the simplest case, the delivered messages are sent and forgotten. If, however, one or more of the application programs 906b assigns a reliable status to one or more of the messages, then these messages may be repeatedly sent to the OBU 605 until the application programs 906b and/or server system 202 receive a return confirmation acknowledgement or receipt.

Also noted in above, ordered delivery manager 1018 can provide order delivery processing of the messages or message chunks. To facilitate the order delivery, one or more of the application programs 906b may assign a particular order to a plurality of the messages. In this case, the particular assigned order is the order in which the messages are to be sent. The OBU 605 may use the order delivery processing to properly process transmitted information. The ordered delivery manager 1018 may collect the messages until the ordered-delivery processing is complete, and then forward the messages to the application programs 906b. Then, the ordered delivery manager 1018 dispatches the messages according to the assigned order. The WCF architecture and functionality supports multiple, independent, ordered delivery queues.

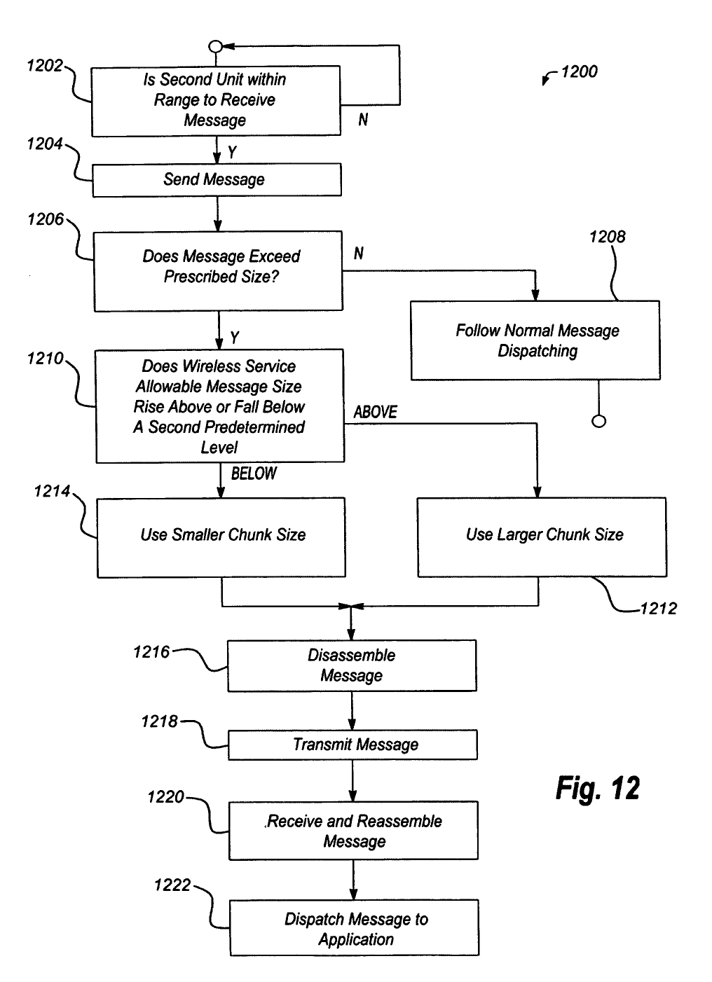

Referring now to FIG. 12, a communication flow 1200 illustrating a dispatch of one or more messages via the messaging API 1012 is described in greater detail. The messaging API 1012 communicates with the transport module 910b of a desired network 706(1-3) via a transport-send agent of the transport manager 1016 to query whether the transport module 910b is allowed to send messages as shown in block 1202. This ensures that the OBU 605 is within range to receive messages before any message is dispatched. Determining whether the OBU 605 is within range of the network 706(1-3) may be facilitated using capabilities of the communication hardware and software of the OBU 605, as is known to one skilled in the art.

If, for example, the OBU 605 is within range of network 706(1) and/or network 706(2), then the messages may be sent in block 1204. If the vehicle is not within range, then block 1202 is repeated until the vehicle becomes within range of the corresponding network. During this wait time, messages may be stored within the message store 1020 by message-storage manager 1018, thereby freeing up the application program 910a to perform other tasks.

With continued reference to FIG. 12, the operation of the multi-part message manager 1026 is described in greater detail. As noted, the multi-part message manager 1026 may disassemble large messages that exceed the maximum allowable size of the selected network 706(1-3). In block 1206, messages sent to the messaging API 1012 from the application program 906b are tested to determine whether they exceed the maximum allowable size for the selected network 706(1-3). If the message size does not exceed this limit, the messages are dispatched according to the flow described in FIG. 11 as shown in block 1208.

If one or more of the messages are smaller than the limit, and then multiple messages can be packaged to reduce overhead for a number of messages. This may be accomplished by placing a number of smaller messages into a packet for transmission over the selected network 706(1-3). This reduces the cost and latency for sending messages over networks that have an overhead cost or additional latency cost for each packet.

If, on the other hand, the size of one or more of the messages exceeds the maximum allowable limit, then the oversized messages may be disassembled as shown in block 1210. To carry out block 1210, the oversized messages may be compared to a prescribed message size to determine the more optimum method for disassembly. The prescribed message size may be used to the balance between efficiencies of sending larger chunks and disassembling the message into smaller chunks, as described previously. This prescribed message size may be an arbitrary or learned byte size specified by the system or it may be a maximum allowable limit dictated by the network on which the message is to be transmitted. Oversized messages that exceed the prescribed message size may be disassembled using the larger or smaller chunk size as shown in blocks 1212, 1214.

In block 1216, the oversized messages are disassembled according to the determination of which chunk size to use. Disassembly may be carried out using identification coding or otherwise marking the order in which the portions of the disassembled messages should be reassembled at the OBU 605. The disassembled messages may then be transmitted to the OBU 605 as shown in block 1218.

The multi-part message manager 1026 keeps track of the portions of dissembled messages that have been transmitted and the portions that have not been transmitted. This allows only the un-transmitted portions of the messages can be later transmitted in case of a failure of system 100 or an out-of-range fault during message transmission. Accordingly, when the system 100 comes back on-line or the OBU 605 comes re-enters the coverage area of one of the wireless communication networks 706(1-3), then entire messages not need to be retransmitted even if the messages are subsequently routed onto a different one of the wireless communication networks 706(1-3).

In block 1220, the messages along with re-assembly information are received in the multi-part message manager 1026 of the OBU 605. Like the multi-part message manager 1026 in the system server 702, the multi-part message manager 1026 also maintains a record of the portions of messages that have been received in case of a failure of the system 100 or an out-of-range fault. Once re-assembled, the messages are sent to the application program 910a of the OBU 605 as shown in block 1222. As noted, the above-described communication are for exemplary purposes only and carried out by in the reverse direction and/or with devices other than the server-system 202 and OBU 605.

In conjunction with FIGS. 10 and 12, the following provides a description of an exemplary operation of the RREM 1028. As noted above, the RREM 1028 may work together with transport manager 1016 to select the desired one of the wireless communication networks 706(1-3) to carry out message transport. Like the other portions of the WCF architecture, the RREM 1028 may be deployed as a customizable component that can be tailored to the server-system 202, remote units, such as OBU 605, and applications 906a, 906b.

In one embodiment, selecting the desired wireless communication network 706(1-3) may be accomplished, in part, by analyzing the number of available networks 706(1-3), transmission timeliness, cost considerations in transporting messages, and other factors. Using a list of available transport modules 910a, 910b, the RREM 1028 may select a network for transport depending on WCF determined message priority alone, or alternatively, in lieu of and/or in combination with priority determined by applications 910a, 910b. For instance, if the application 901a sets the priority of a given set of messages to a high degree of urgency, then the RREM 1028 may route messages through one of the networks 706(1-3) that provides high transmission speed, broad geographic coverage, and/or highly-reliable message delivery. Alternatively, messages requiring high urgency can be routed through multiple, rather than one of the networks 706(1-3) to ensure that the messages are received in the fastest and most reliable manner. In another alternative, if many messages are available for delivery, the RREM 1028 may dispatch the messages with the highest priority message first.

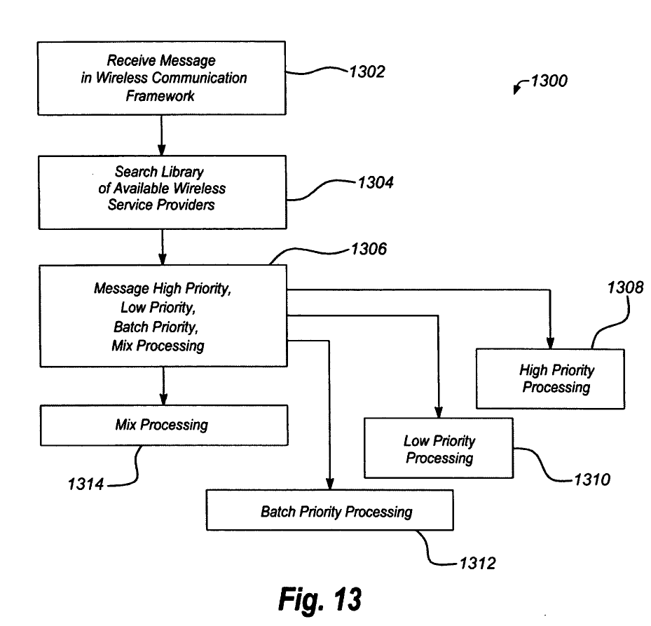

FIG. 13 illustrates a flow chart depicting another communication flow 1300 between the service server 202 and the OBU 605. In communication flow 1300, one or more messages are dispatched from the server system 202 to a remote unit, such as OBU 605. Like above, the flow 1300 may also be carried out by in the reverse direction, i.e., originating from the OBU 605 and terminating at the server system 202. Moreover, other devices besides the server system 202 and the OBU 605 may carry out the following flow.

At block 1302, the server-system portion of the WCF architecture receives one or more messages from one or more of the application programs 910b. Before sending the messages, however, the application programs 910b may assign a particular priority to each of the messages. This priority, for example, may be set to a low priority, which indicates that the message or messages need not be sent with urgency. Alternatively, the priority may be set to a high priority, which indicates that the message or messages need to be sent with some degree of urgency and be delivered soon.

The priority may also be set to a batch priority. The batch priority may indicate to the WCF architecture that the messages may be held in a queue, e.g., the message store 1020, until other messages with the same priority level are accumulated. Once accumulated, the group of messages can be then sent as one batch.

Alternatively, the priority assigned to one or more of the messages may be multi formatted. In this embodiment, the messages may have a low priority for a predetermined time. After the predetermined amount of time is expended, the WCF architecture may be notified that the message has not been sent. The WCF architecture then can reassign the priority for the messages or take a different action to dispatch the message with greater urgency.

At block 1304, the API 1012 may determine which of wireless communication networks 706(1-3) are available to the OBU 605. Each of the messages' priority is reviewed to determine whether high, low, multi-formatted (mixed processing) or batch priority conditions exist, as shown in block 1306.

High priority processing is carried out for messages having a high priority, as shown in block 1308. Low priority processing is executed for messages having a low priority, as shown in block 1310. Batch priority processing is executed for messages having a batch priority as shown in block 1312. It should be noted that many different levels of priority are possible can be assigned. In each case, the severity of the urgency of the priority assigned by the application programs 906b may be “escalated,” “de-escalated,” or otherwise changed by the RREM 1028 depending on the factors mentioned above.

The high priority processing of step 1308 may use the RREM 1028 to identify the most reliable coverage service provider. Then the RREM 1028 works together with the transport manager 1018 to select the transport module for the service provider that may provide the most reliable service. Messages are then sent via the wireless communication networks 706(1-3) of the selected service provider. Alternatively, the RREM 1028 may review the available service providers to determine the fastest, broadest coverage area, etc. for delivering the high priority messages. On the other hand, the RREM 1028 may review the available service providers to determine lowest cost provider for low priority messages. The least-cost routing manger 1024 may links to the transport manager 1018 for the low cost wireless provider, and then transmits the messages via the low cost service provider. Batch priority processing of step 1210 is used for very low priority messages, which may be batched together and dispatched at one time. For this, the RREM 1028 may use message manager 1014 to batch messages together and send them at one time.

In block 1314, multi-formatted or mix processing may be carried out if the message priority is assigned by the application programs 906b. For instance, messages provided from the application programs 906b may be tagged with a low priority number for a predetermined period of time. If the message is not sent within that predetermined period of time, then the RREM 1028 processes the message as a higher priority message.

Accordingly, in block 1314, the RREM 1028 attempts to send the message via a low cost wireless service during the predetermined time. If the message is unable to be sent through the low cost wireless service within the period time, then the RREM 1028 reassigns the message to be sent via a high speed, higher cost, greater coverage or more reliable network to increase the ability of the message to reach its destination. As noted, the above-described communication flow 1300 is for exemplary purposes only and carried out by in the reverse direction and/or with devices other than the server-system 202 and OBU 605.

6 System Operation Examples

The overall system 600 can support many possible services and applications, examples of which are described below and illustrated in FIGS. 14 through 18. As noted above, the system 600 shown in FIGS. 6 and 7 illustrate one possible relationship between services and applications for a system 600 using an ASP-based model. In one embodiment, a group of core services 650 that perform vehicle-specific operations are available to the applications 608, 610.

As noted above, the applications 608, 610 allow a user to customize the interpretation and display of the vehicle-specific operations based on the user's own requirements. The core services 650 act as building blocks of services that can be selected or combined in any desired manner, and can be accessed by or with any applications 608, 610 in the system 600; in other words, the applications 608, 610 act as a functional layer over the more primitive core services 650. For example, the core services 650 may be accessed by a help desk application to obtain vehicle location along with parametric data or by a service application to obtain parametric data and to perform functional tests. Because the system 600 can leverage other applications and services that the system 600 itself may not have and couple them with its own applications and services, the system 600 provides a flexible and adaptable platform that can accommodate many different needs, including integration into the ERP system 300.

In one embodiment, the applications may assemble the core services to perform specific functions. For example, one of the core services 650 may capture measured values and/or change parameters or operational settings in the vehicle 604 while the applications 608, 610 organize and process information from the core services 650 into groupings that are meaningful to a given user. A service outlet, for example, may want different data and/or data organized in a different manner than a leasing organization or a component manufacturer.

As noted above and as shown in FIGS. 6 and 7, the interface 606 can be a browser interface or graphical user interface (GUI) that allows a human user to access the system 600, or a machine-to-machine application programming interface (API). The user interface 606 allows the system 600 to act as a gateway between the user and the vehicle(s) 604 via the applications and services.

As noted above, the core services 650 provided by the system 600 acts as building blocks that can be assembled by applications in a variety of ways that can best serve the user. Possible core services 650 include:
Parameters: obtains discrete or data stream-based vehicle parameters, including standard and proprietary messages, upon user request;
Alerts: notification of the occurrence of a particular event (e.g., receipt of a trouble code or a notification of a parameter value occurring outside an acceptable parameter range);
Functions: runs functional tests on vehicle components and generates result reports;
Configuration: performs remote configuration of a vehicle or component by, for example, changing one or more vehicle parameters;
Reprogramming: performs complete reprogramming, or “re-flashing” of a selected on-vehicle controller;
Geographic location: provides vehicle location through, for example, a GPS system.

The list of core services 650 above is not meant to be exhaustive, but are simply examples of possible services that can be available directly to users or supplied to applications for further processing. Note that although the explanations below focus on obtaining data from a vehicle ECU 808, the system and functions described below are applicable for any vehicle data.

The “Parameters” service may include a simple parameter retrieval service as well as more sophisticated parameter retrieval services that address limitations in obtaining vehicle data when, for example, the vehicle is turned off. FIG. 14 illustrates one simple process 1400 for obtaining a parameter. When the OBU 605 receives a command from the system server 702 to retrieve a data value at block 1402, the OBU 605 sends a query message to the ECU 808 to obtain the ECU's current reading at block 1404. Once the ECU 808 returns a parameter value at block 1406, the OBU 605 retrieves the value and forwards it to the system server 702 at block 1408. Note that frequently used parameters may be packaged and transmitted to the system server 702 as a single message as a more efficient way of transferring data. Further, the specific means for getting a particular data item may depend on the specific requirements of a given ECU 808. For example, as is known in the art, data points corresponding to an anti-lock brake system may be obtained in a different manner than data corresponding to engine coolant temperature.

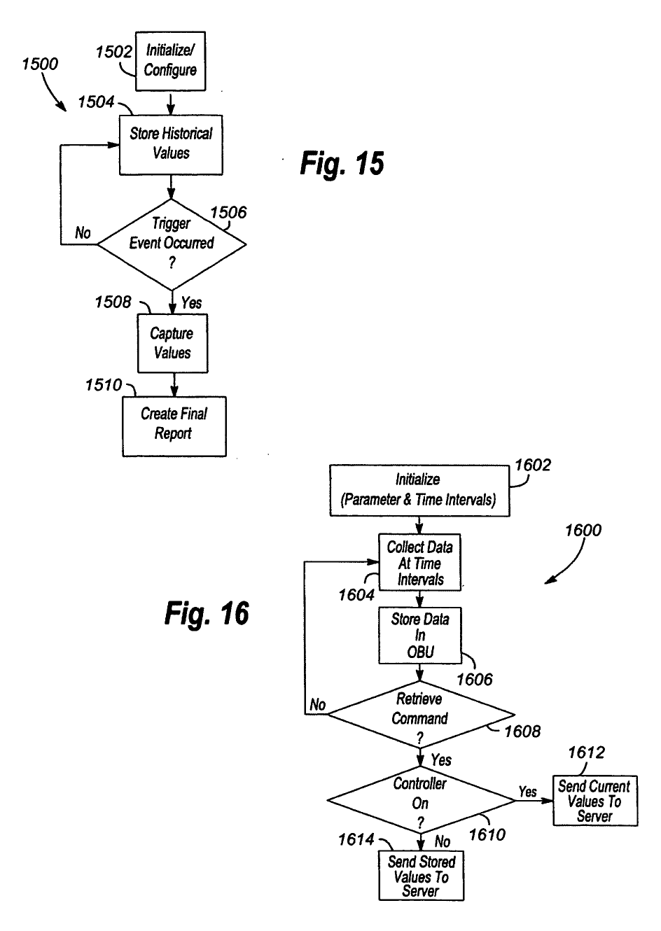

FIG. 15 is a flowchart illustrating one possible process to be offered as a “Parameters” service that is more sophisticated that the simple parameter retrieval service explained above. Although parameter data can simply be read from the vehicle's electronic controllers and provided to the user on demand, the “Parameters” service can also provide more sophisticated parameter data capture methods such as the type shown in FIG. 14.

FIG. 14 illustrates a “snapshot” process 1400 for obtaining a set of parameter values over a period of time, where the reporting of the parameter values is triggered by a specified event. Offering this service as an on-vehicle diagnostic tool is particularly helpful for intermittent fault diagnosis and vehicle performance analysis. Further, gathering data sets at prescribed periodic intervals minimizes negative effects caused by inherent problems in wireless communication systems, such communications drop-out and lack of coverage, which would normally make remote diagnostics ineffective.

To carry out the snapshot process 1500, the system 600 first initializes at block 1502 by, for example, storing the diagnostic parameters to monitor, setting the time intervals at which parameter values are captured, selecting the number of captured values to be included in a single report, and selecting the event that will trigger reporting of the captured values. This information can be inputted into the OBU 605 via the interface 606. The parameter values to be captured can be any parameters accessible on the vehicle's electronic controllers by means of a diagnostic data stream or from discrete inputs on the OBU 605. The triggering event can be any non-continuous event that is monitored on the vehicle, such as the capture of an active trouble code from a vehicle controller or a parameter moving outside an established acceptable range.

Once the OBU 605 has been configured (block 1502), the OBU 605 maintains a number of historical value sets at block 1504 by caching a selected number of parameter readings during normal vehicle operation. While the OBU 605 captures the parameter readings, it also waits for the triggering event to occur. Once the trigger event occurs (block 1506), the OBU 605 continues caching the configured parameter readings occurring after the event (block 1508). The number of historical value sets can be, for example, half the number of captures to be included in the final report, while the number of value sets taken after the triggering event can make up the other half. Note that the OBU 605 may, in another embodiment, capture parameter readings only before or after the triggering event as well or capture different numbers of values on either side of the event.

After all of the desired value sets have been captured and collected, all of the captured readings, both before and after the event, are combined into a final report at block 1510. The report can be stored on the OBU 605 for later retrieval or sent via wireless connection to the application server 702a for immediate viewing.

Another possible process that can be offered as a “Parameters” service is a “get stored values” (GSV) process 1600, as illustrated in FIG. 16, for collecting parameter values from a vehicle even if the vehicle is unable to provide current parameter values at the time of the query. The GSV process 1600 addresses a situation where the vehicle controllers 808 are unable to respond to a query by the OBU 605 (e.g., while the vehicle is turned off) to respond to a query. This process is particularly useful in applications requiring remote retrieval of time-sensitive data, such as an odometer reading at the end of a scheduled period, or in any application where the vehicle operating state is unknown at the time of the query.

For the GSV process 1600 to be effective, the OBU 605 should be designed to allow continuous remote access so that the OBU 605 is always ready for receiving and sending messages. The OBU 605 is initialized by receiving an instruction to periodically collect specified parameter data at a selected query time interval (block 1602). After receiving this command, the OBU 605 will periodically collect data at the specified query time intervals (block 1604). The values gathered by the OBU 605 are stored in the on-board unit's memory, such as a flash memory, at block 1606 before the OBU 605 is shut down when the vehicle 604 is turned off.

If the OBU 605 receives a GSV “retrieve” command from the application server 702a (block 1608), the OBU 605 checks the state of the vehicle controller 308 at block 1610. If the vehicle controller 808 is accessible, then the OBU 605 collects the current values from the vehicle controller 808 at that time and sends the collected current values to the system server 702 (block 1612). If the vehicle controller 808 is not available at the time of the command (e.g., if the vehicle is turned off), making the current values of the controller 808 irretrievable, the saved values in the OBU 605 are sent back to the system server 702 as the retrieved values (block 1614).

By periodically collecting data at selected intervals while the vehicle controller is operational, the OBU 605 can at least obtain recent vehicle controller parameter readings before the controller 808 is inaccessible at some later time. As a result, the GSV process 1600 allows the system server 702 to obtain the most recent controller data if current data is not available at the time of the query. In short, the GSV process 1600 returns the last known value in memory to the system server 702 if the vehicle is turned on and will retrieve a backup value, which may still be the last known value in memory, if the vehicle is turned off.

Multiple “Alerts” services may also be provided as a core service in the system 600. In its simplest form, the “Alert” service monitors vehicle trouble codes and transmits a message to the OBU 605 when the trouble code occurs. For example, a fault code may come as solicited or unsolicited, depending on how the controller 808 in the OBU 605 is instructed to handle faults. To obtain an unsolicited fault, the OBU 605 monitors the vehicle data bus 807 the occurrence of a fault and notifies the system server 702 if a fault occurs. If only a set of individual faults are monitored, additional parsing shall be performed to filter out unwanted faults. For example, if a user only wishes to be informed of fault codes corresponding to a component breakdown, as opposed to being informed of all fault codes, the user can indicate this preference via the interface 606.

To obtain a solicited fault, the user may set up periodic queries to the OBU processor 800 in addition to setup notification. Note that the response message may match the message template even if no fault actually existed; in this case, additional parsing of the response message may be necessary to obtain useful information. For example, if the user solicits a request for information, the user may obtain a response based upon the criteria of that request, which may be different than the criteria for unsolicited notifications.

If desired, the “Alert” service may include additional functions such as providing the ability to add/remove individual faults, canceling the alert function for a given fault when a fault alert is fired so that only the first fault occurrence (and not subsequent fault occurrences) trigger a notification message, or configuring the “Alert” service to be stored permanently in, for example, the database server 202d until the user removes the service or until the service is cancelled by a fault occurrence.

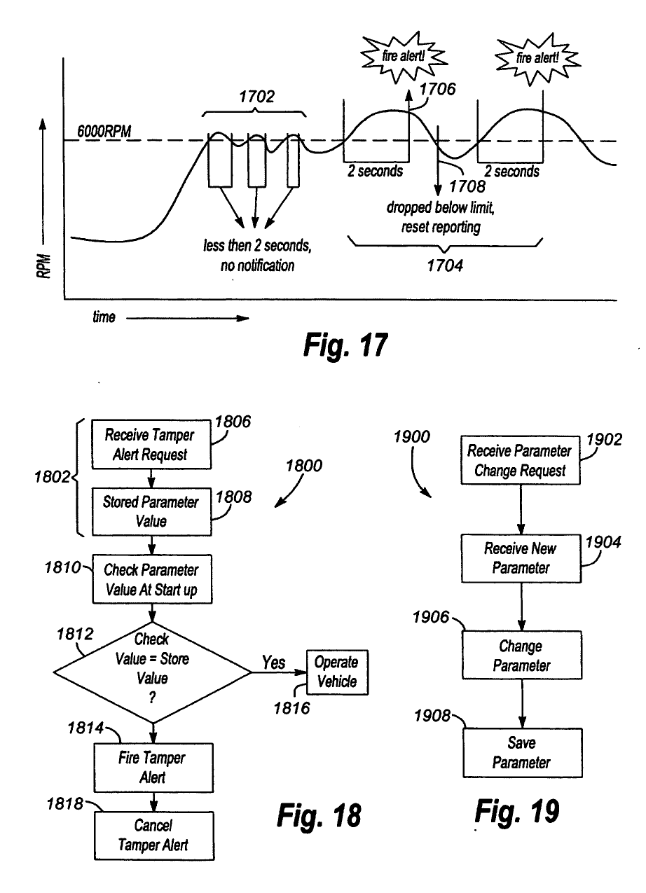

With respect to the example shown in FIG. 17 and as noted above, the “Alerts” service may include among its functions the detection of a particular event by checking whether a monitored value exceeds a selected threshold. Note that although this example focuses on one diagnostic parameter, any number of diagnostic parameters may be combined into an algorithm to detect threshold limit boundaries. Further, values may be monitored over time, rather than as one single alert-triggering event, to monitor patterns and trends and to detect events more accurately.

As an example of an “Alert” service that monitors over time, FIG. 17 shows an “Over RPM” threshold alert example that detects if a vehicle driver is abusing the vehicle engine. In this example, the Over RPM threshold alert considers the amount of time that the RPM level exceeds a specified limit (6000 RPM in this example) rather than simply generating an alert each time the RPM exceeds the level. The time delay ensures that alerts are generated only for events that may cause genuine concern.

As shown in FIG. 17, if the RPM exceeds 6000 RPM for a brief period that is less than 2 seconds (at 1702), the “Alert” service does not generate an alert. However, if the RPM does exceed 6000 RPM for more than two seconds (at 1704), the service fires an alert 1706 and resets itself (at 1708) when the RPM drops back below 6000 RPM. The actual circuitry for monitoring RPM and implementing this example of the “Alert” service in the system 600 (e.g., on the OBU 605) is well within the skill of those in the art. Further, the time delay concept shown in FIG. 17 can be used for any parameter where undesirable operation is preferably detected via time and value thresholds.

The “Alert” services may also include a tamper alert feature that, as shown in FIG. 18, allows the user to monitor any unauthorized alteration of configurable parameters. This feature 1800 generally contains a setup process 1802 and a tamper check process 1804. When a user requests the tamper alert service (block 1806), the OBU 605 captures the value of the parameter at the time of the request and saves the parameter value to a file in the OBU's memory (e.g., OBU's flash memory 815 or DRAM 816) at block 1808. Note that this parameter retrieval process may involve using the “Parameters” service as explained above to query the ECU or other vehicle controller or component 808.

The actual tamper check process is conducted when, for example, the vehicle is initially turned on. At this point, the OBU 605 checks the parameter again to get its current value at the time the vehicle ignition is turned on (block 1810). If the current value is different than the saved value (block 1812), a tamper alert message will be returned to the user (block 1814). If the compared values are the same at block 1812, however, the vehicle continues operation as usual without transmitting any tamper alert signal (block 1816). In one embodiment, the user may add/remove individual tamper alerts, and the tamper alert may be cancelled at block 1818 once the alert is fired.

A “Change Parameters” function may also be included as part of a configuration core service, as shown in FIG. 19. This feature may allow a user to remotely insert or update, for example, a parameter or message definition in the vehicle. As shown in FIG. 19, the function 1900 includes receiving a parameter change request (block 1902), receiving the specific parameter to be changed in the vehicle (block 1904), changing the parameter (block 1906), and saving the parameter in memory (block 1908). In one embodiment, the updated parameter definitions are stored permanently in memory until the next change request. Further, in one embodiment, the updated definition takes effect as soon as the update is completed.

The core services can be accessed by one or more applications, as noted above. The system 600 may include the ability to leverage other services that it may or may not have, such as, Fuel Tax Reporting/State Line Crossing applications, Asset tracking/utilization programs, Driver Performance applications, On-line Vehicle Documentation, detailed mapping applications, etc. This flexibility, coupled with modular services and applications 608, 610 that can be added, subtracted, and combined at will, provides for a very flexible and adaptable platform.

7 Applications

As described above, the system 600 allows users to customize their own vehicle monitoring, programming and diagnostics systems based on their own specialized needs by offering a plurality of applications that can be selected and combined in a modular fashion as desired by the user. The applications may include service offerings such as Remote Diagnostics, Fuel Economy, Trip Reporting, Automatic Vehicle Location based upon GPS or satellite based system information, and others. The applications listed here and described in greater detail below are only examples and are not meant to be limiting or comprehensive in any manner. Those of skill in the art will understand that other applications may also be included as possible application options.

A “Remote Diagnostics application for example, provides the ability to perform component analysis before or during a vehicle breakdown and allows vehicle maintenance locations to receive parametric information from a vehicle prior to its arrival, or prior to dispatching a technician to the vehicle. Further, the “Remote Diagnostics” application allows a technician to perform selected diagnostic tests on the vehicle or system, with the test process being managed by the OBU 605.

In one embodiment, the “Remote Diagnostics” application allows a user to view parameters, active and inactive fault codes, and vehicle configurations, for example, and may also allow authorized users to perform functional tests and configuration changes on the vehicle. Remote Diagnostics may be initiated when, for example, a vehicle notifies a fleet manager about a series of established alerts or when the diagnostics are requested manually by a fleet authorized user. In practice, the application may provide diagnostic applications via the system 600.

When the user logs on to the system 600 via the interface 606, for example, he or she may be presented with a list of vehicles that have reported alerts or notifications that may need attention. If no alerts are active, the user is provided a list of vehicles for which he or she is responsible. At this point the user may elect to use a remote diagnostics application, such as the remote diagnostics application described below and shown in FIG. 19, 1913, to perform further analysis on the vehicle to determine the severity of the problem.

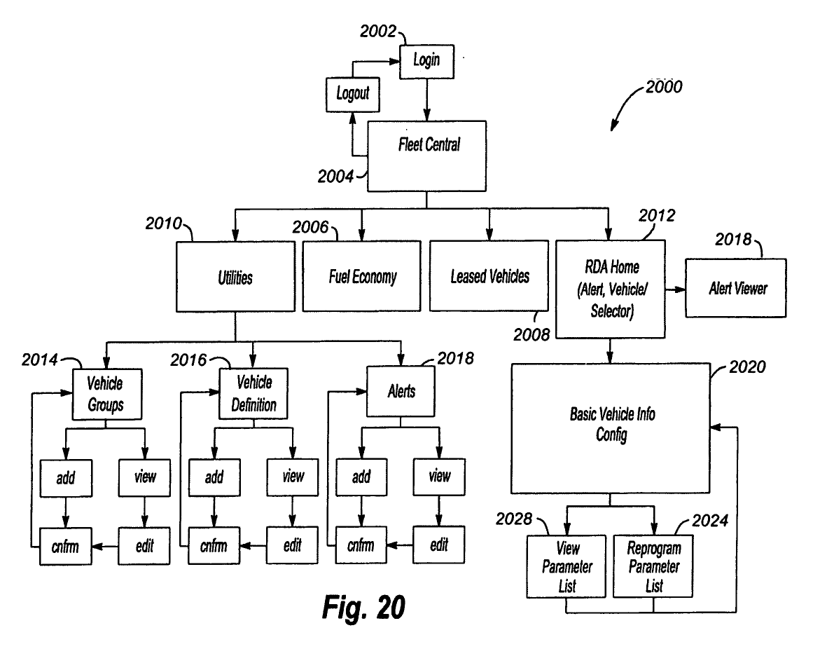

FIG. 20 is a block diagram illustrating one possible overall web site architecture 2000 that includes a remote diagnostics application. In this example, a user may log into the application (block 2002) to reach an application home page 2004. From the home page, the user may access a range of information, such as fuel economy 2006 or leased vehicle information 2008, or access utilities 2010 or a remote diagnostics application (RDA) page 2012 to monitor, diagnose, and/or reprogram vehicle parameters. In this example, the utilities 2010 allow the user to define and/or modify vehicle groups 2014, specific vehicles 2016, and alerts 2018. The RDA page 2012 provides users with access to, for example, vehicle information and parameters 2020, including pages that allowing parameter viewing 2022 and reprogramming 2024. Note that other architectures and implementations are possible for this application as well as other applications without departing from the scope of the invention.

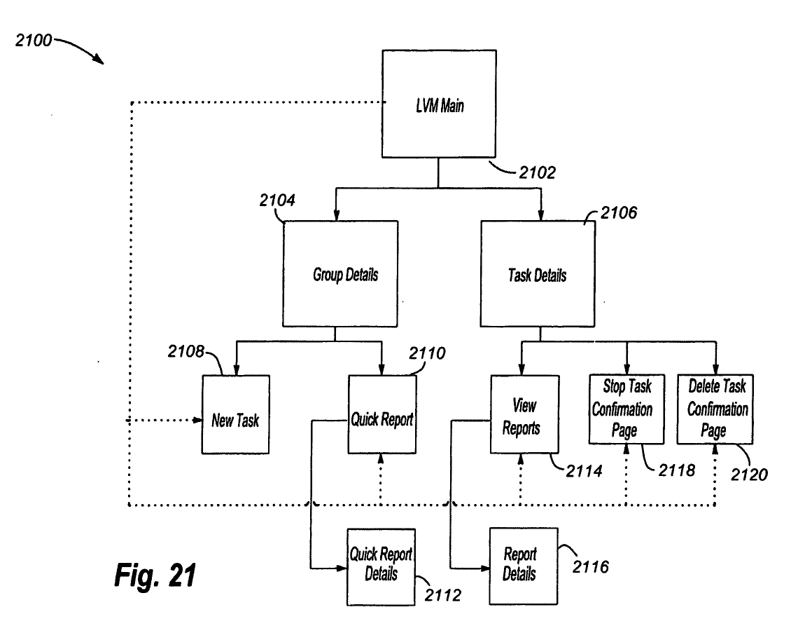

A “Leased Vehicle Management” (LVM) application is another possible option to generate periodic status reports summarizing selected parameters for each vehicle in a fleet, such as total vehicle distance, total idle fuel, total idle time, total fuel used, and/or total fuel economy. FIG. 21 is a block diagram illustrating one possible example architecture for the Leased Vehicle Management application 2100. In this example, the user reaches a main page 2102 that allows the user to choose between a group details page 2102 and the task details page 2106. Group details 2104 correspond to all information for a selected vehicle group, while task details 2106 correspond to all information for a selected task.

The group details page 2104 may allow the user to, for example, create new tasks (e.g., the timing of data collection for a selected vehicle group) 2108, generate a report list 2110, or generate more detailed reports listing specifying, for example, parameter values for a selected report 2112. The task details page 2106 includes similar options, allowing the user to view reports for a selected task 2114 and generate more detailed reports 2116. The task details page 2106 also allows a user to stop a task 2118 or delete a task 2120.

An “Engine Management” application may also be an option to target fleets whose vehicles encounter varying road and traffic conditions, and varying load types and weights. The objective of the “Engine Management” application is to improve overall fleet fuel economy via dynamic control of a vehicle”' operational characteristics, in particular, horsepower ratings and maximum road speed limits. Traditionally such operating parameters have been established once at a fleet wide level, not taking into consideration some of the variables listed above. In addition, making these changes required physical contact with the vehicle, necessitating undesirable vehicle downtime. Dynamic adjustments based upon operating conditions can provide reductions in vehicle operational costs, thus resulting in significant savings at a fleet level. With this application the user will be able to dynamically configure the vehicle wherever it may be; tailoring its operational characteristics based upon route, load, and other vehicle operation factors. The “Engine Management” application may include both measured parameters and programmable parameters. Examples of programmable parameters include Vehicle Road Speed Limit, Engine Horsepower/Torque, Engine Idle Shutdown Time and Cruise Control Settings.

A “Trip Report” application may also be provided as an option. This application allows the fleet manager to obtain trip information from the vehicle on a near-real-time basis. The user can analyze trip information for single vehicles as well as any increment of their fleet. This application primarily uses measured parameters such as odometer readings, total trip fuel, idle fuel, average fuel economy, vehicle route taken, and others. It also uses some parameters to derive data, such as total idle hours and the type of idle hours recorded. The output from this application can also be used as input to the billing systems of leasing companies who charge customers based upon mileage.

A “Maintenance Alert” application allows the fleet manager to establish a series of maintenance triggers based upon key parameters. When a parameter threshold is encountered, the fleet manager will be notified automatically by the system, thus initiating a maintenance event without physical contact with the vehicle. For example, a fleet may establish a preventive maintenance cycle based upon odometer reading. If the system server 702 is made aware of the interval, it can notify the fleet of the precise moment when that interval occurs. Alerts may provide notification on parameters such as diagnostic codes, fluid levels and parameter ranges as well as unauthorized tampering with the vehicle.

A “Vehicle Configuration” application may be offered to allow a fleet manager to set certain parameters for multiple vehicles in a fleet so that the selected vehicles will operate within its established standards. Examples of parameters include horsepower ratings, maximum road speed limits, maximum and minimum cruise control set speeds and maximum engine idle time before shutdown. Traditionally, this step has required a physical connection of a diagnostic application or tool to the vehicle, but physical connections are time-consuming and require the same step to be repeated on every vehicle that is serviced. The wireless nature of the “Vehicle Configuration” application allows operational settings and alerts for several vehicles within a fleet at one time by allowing the user to identify selected vehicles, set parameters, and initiate an automated process where each vehicle is systematically configured with the same parameter settings.

A “Warranty Management” application may also be offered as part of a data mining strategy used by, for example, original equipment manufacturers (OEMs) to help diagnose warranty relationships between major components or to assess warranty claims for validity. This application would, for example, obtain detailed vehicle data from the database server 202d, using both fleet specific and system-wide data mining, and then correlate the data with warranty requirements.

As noted above, the possible modular applications described herein are meant as illustrative examples only. Further, as noted above, the applications 608, 610 accessed by the infrastructure 602 can be generated by third parties and offered as modules for incorporating into a particular user”' interface 606 and accessing the OBU 605 and other system-supported core services and applications. The modular functionality offered by independent applications 608, 610 allows disparate users to access the same vehicle data via the same OBUs 605 and the same infrastructure 602, but be offered customized data, functionalities, and interfaces that are meaningful to that user”' industry as determined by the particular modular applications selected by the user. The specific manner for implementing the applications via, for example, computer programs, is within those of skill in the art.

The inventive system therefore provides a modular wireless vehicle diagnostics, command and control system that is customizable to user specifications. More particularly, the modular applications 608, 610 provide much versatility and allow users from disparate industries to use the same overall inventive system 600 by selecting the applications 608, 610 relevant to their particular industry. Further, by creating a wireless diagnostics and command and control service, the invention provides real-time remote access to vehicles and vehicle systems via, for example, the Internet and wireless networks. In one embodiment, the inventive system allows users to connect to multiple data points on any given vehicle to interpret and analyze the vehicle data in real time, change vehicle parameters as needed and create historical databases to guide future decisions. Further, by monitoring vehicle operation in real time and providing customized reports for each vehicle, the inventive system achieves high operating efficiency, lowered maintenance costs and downtime, and even allows pre-ordering of parts as vehicles approach scheduled maintenance.

Note that the capabilities described above are meant to be illustrative and not limiting. The system 600 can be adapted to, for example, establish a setting that is applied to selected group of vehicles with a single command rather than individually establishing a setting for each vehicle. The aspects of the request, including authorization, vehicle/component differences, password differences, and configuration limitations of the specific request, may be managed by, for example, the system server 702.

In another embodiment, the system 600 can view each vehicle 604 as a single entity to allow the user to communicate with multiple ECU”' on the same vehicle 604 at the same time. For example, data can be obtained from an Engine ECU and Transmission ECU at the same time, with the resultant data from each controller correlated to the other to add more detail to the data offered to the user.

8 Extending Telematic, Diagnostic and/or Prognostic Systems to an ERP System

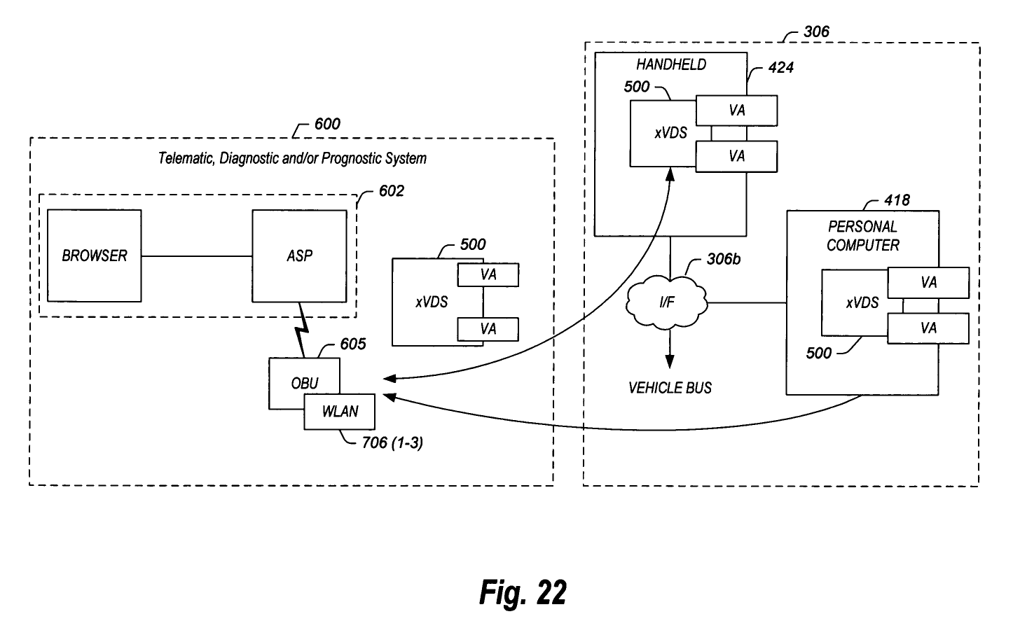

FIG. 22 is a block diagram illustrating a telematic, diagnostic and/or prognostic system, such as system 600, that is extended into the a vehicle diagnostic and information system, such as the VDIS 306, and in turn to an ERP system, such as the ERP system 300. As above, the system 600 includes the ASP infrastructure 602, which is configured to communicate with the OBU 605. In the embodiment shown in FIG. 22, the ASP infrastructure 602 and OBU 605 employ the xVDS framework 500 to carryout vehicle applications, such as those listed above.

The VDIS 306, as above, may include a handheld diagnostics scan tool 424 and a personal computer 418, both of which are configured to be communicatively coupled to the vehicle 110 via the interface adapter 306b. To take advantage of the power, flexibility and scalability of the xVDS framework 500, the xVDS framework 500 may be ported to the handheld diagnostics scan tool 424 and/or a personal computer 418, given its operating system and vehicle application abstraction layers.

After porting the xVDS framework 500 into the architecture of the handheld diagnostics scan tool 424 and/or the personal computer 418, vehicle applications can be created, downloaded from a memory and/or maintained in the handheld diagnostics scan tool 424 and/or a the personal computer 418. This capability of the xVDS framework 500 allows the handheld diagnostics scan tool 424 and/or a personal computer 418 to, for example, communicate with an on-board vehicle controller, such as a Detroit Diesel DDEC III controller, and to perform diagnostics, including (i) programming its allowable horsepower, (ii) reading its instantaneous or other measurement of horsepower, (iii) setting the maximum cruise speed, etc. When complete, the handheld diagnostics scan tool 424 and/or a personal computer 418 can then be configured to communicate to another or new controller, such as a WABCO Hydraulic Brake System controller. This may be facilitated by an insertion of a vehicle application for such purpose.

(a) Exemplary Workflow Architecture

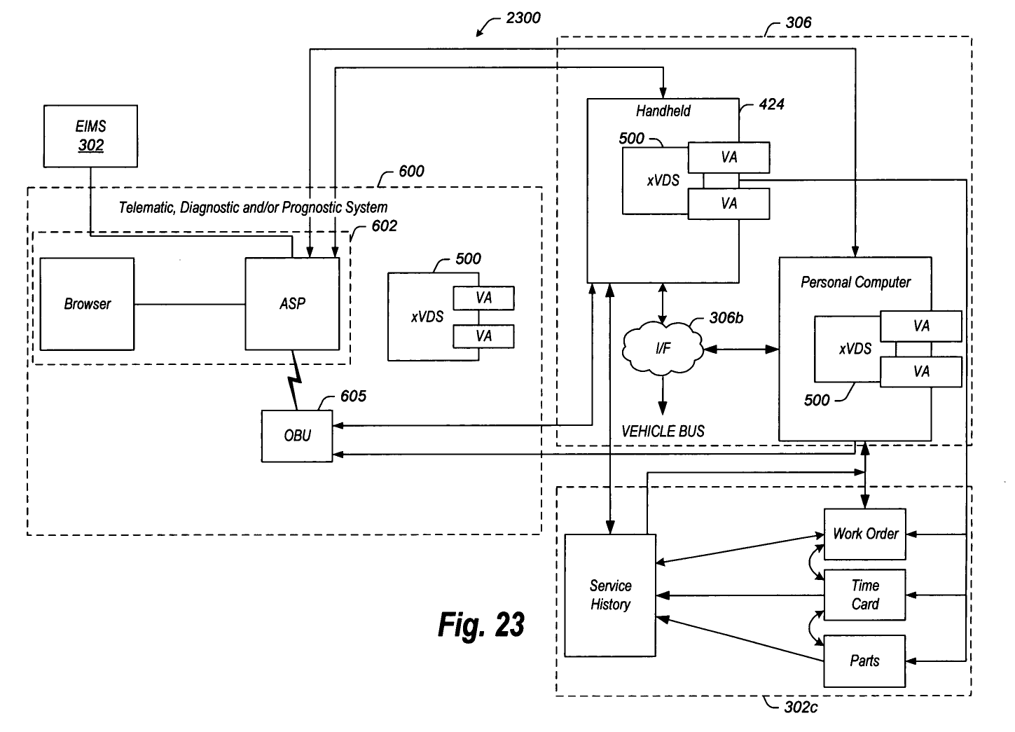

FIG. 23 is a block diagram illustrating an exemplary workflow architecture 2300 for carrying out a vehicle servicing workflow in an enterprise-resource planning system, such as the ERP system 300. In this workflow architecture 2300, a telematic, diagnostic and/or prognostic system, such as system 600, may be extended into a vehicle diagnostic and information system, such as the VDIS 306, and in turn, into the ERP system 300.

The system 600 includes the ASP infrastructure 602, which is configured to communicate with the OBU 605, the EIMS 302, and the VDIS 306. The ASP infrastructure 602 and the OBU 605 employ the xVDS framework 500 to carryout one ore more vehicle applications. The VDIS 306 may include the handheld diagnostics scan tool 424 and/or the personal computer 418, both of which are configured to be communicatively coupled to the vehicle 110 via the interface adapter 306b. The handheld diagnostics scan tool 424 and personal computer 418 may employ the xVDS framework 500 as well.

The flow 200 in FIG. 2 may be carried out in this alternative architecture 2300 with a few minor variations. These minor variations include changes to the routing of information in the alternative architecture 2300. For example, instead of the handheld diagnostics scan tool 424 and/or personal computer 418 communicating with the information-processing server 302a, they communicate to the ASP infrastructure 602, which in turn, communicates with the EIMS 302. Further, the handheld diagnostics scan tool 424 and a personal computer 418 may communicate to the on-board electronics or electronic systems via the interface adapter 306b or via the OBU 605. Other modifications are possible as well.

(b) Exemplary Workflow Architecture for Expert Advice Application

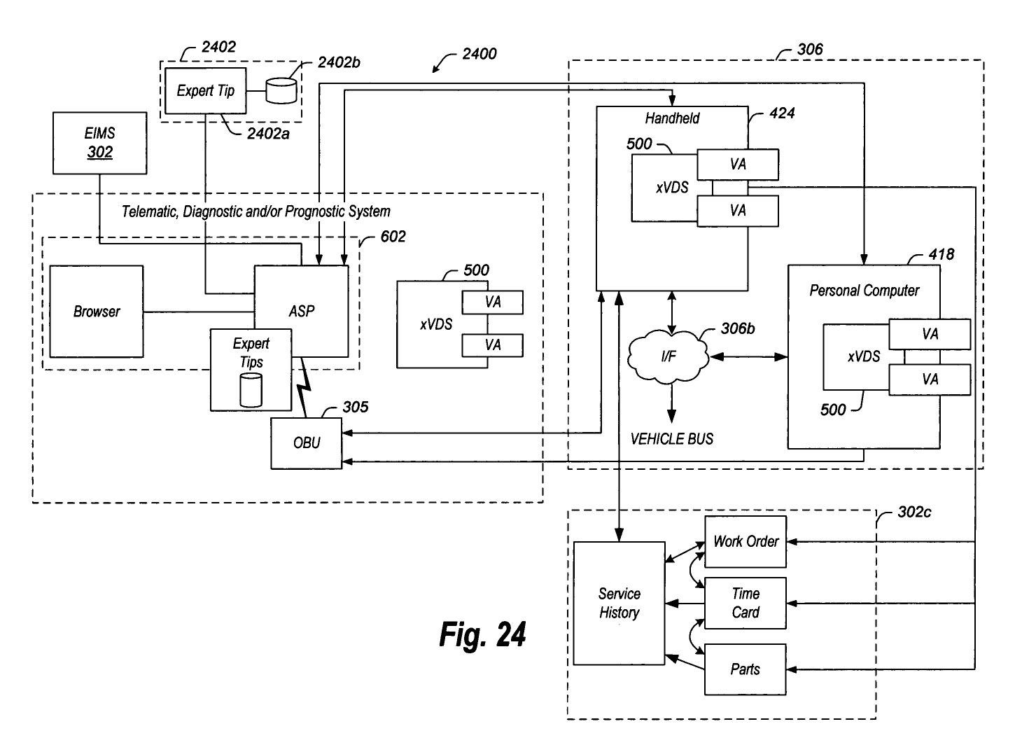

FIG. 24 is a block diagram illustrating a second workflow architecture 2400 for carrying out a vehicle servicing workflow in an enterprise-resource planning system, such as the ERP system 300. The second workflow architecture 2400 of FIG. 24 is similar to the first workflow architecture 2300 of FIG. 23 in most respects, except as described below.

In this workflow architecture 2400, a telematic, diagnostic and/or prognostic system, such as system 600, is extended into a vehicle diagnostic and information system, such as the VDIS 306. Through an expert advice or tips system 2402, which may include an expert advice application 2402a and a data store 2402b for housing expert information, the VDIS 306 and system 600 may access and/or download to the ASP infrastructure 602 the expert information (e.g., fault code interpretation) for diagnosing vehicle problems. This expert advice application 2402b may be coupled with a guided-diagnostics application to aid in the diagnosis and resolution of vehicle problem or, more generally, a service event.

For example, as the service technician services the vehicle, he or she may note that a customer reported conditions A, B and C, and the handheld diagnostics scan tool 424 and/or the personal computer 418 indicates a fault code D has been set. From this, the expert advice or tip system 2402 may prompt the service technician to trigger or, alternatively, automatically cause the handheld diagnostics scan tool 424 and/or the personal computer 418 to obtain and analyze specific parameters under certain conditions. Then, based-on the analysis, the handheld diagnostics scan tool 424 and/or the personal computer 418 may obtain and analyze other parameters under another set of conditions so as to drill down to a potential resolutions.

After arriving that the potential resolutions the guided-diagnostics application may instruct the service technician to replace a part or make some other modification to cure the problem or address the service event. The guided-diagnostic application may interact with the office applications 302c to (i) update the work order with the diagnostics performed, (ii) update the time-accounting application for the time spent on the guided-diagnostics, (iii) access the parts inventory so as to alert the parts department to pull necessary parts from stock, and/or (iv) retrieve and/or update the vehicle's service history.

(c) Exemplary Guided-Diagnostics Application Architecture

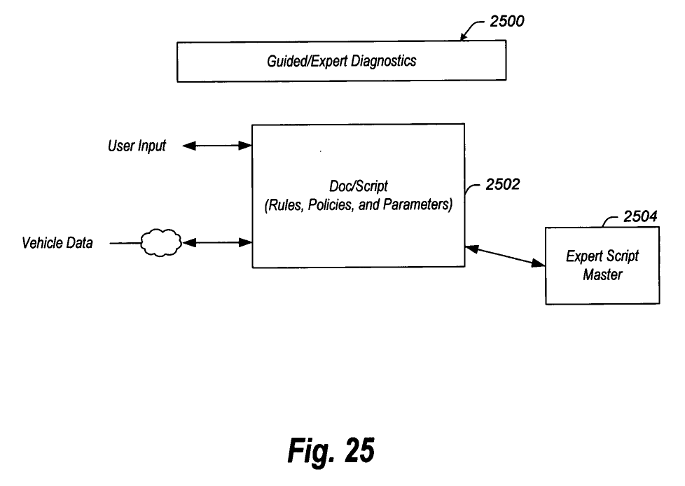

FIG. 25 is a block diagram illustrating an exemplary guided-diagnostics application architecture 2500 for carrying out guided-diagnostics in an ERP system, such as the ERP 300. The exemplary guided-diagnostics application architecture 2500 may be carried out in a telematic, diagnostic and/or prognostic system, such as system 600, and/or vehicle diagnostic and information system, such as the VDIS 306.

The guided-diagnostics application architecture 2500 may be a logic engine that may be implemented in a script 2502. This script 2502 may be in a format such as XML or some extensible computer-readable format that may be edited, and devised to carry both the instructions and data (or at least links for the data).

An execution engine for the script, which may be for example, a web server, may first interrogate the script 2502 to determine the problem (e.g., diagnosis of a fault code, a reported symptom or something else) that needs to be resolved. The script 2500 then guides the service technician through a number of steps toward resolution.

If, however, a decision needs to be made on conditions that require vehicle data, the guided-diagnostics application may request that the VDIS 306 run one or more of the vehicle applications to obtain and return the necessary vehicle data to attempt to find a resolution to the problem or service event. The guided-diagnostics application may provide or be configured to provide the service technician with the ability to override the expert systems' conclusion in the diagnostic process.

The script 2502 may be configured to self-correct in that it may be updated automatically using statistical learning techniques; thereby extending the expert system. For example, the guided-diagnostic application may proceed to a point at which it has no answer. In such a case, the service technician has to determine the resolution. This may be done with or without the use of the VDIS 306.

Once a resolution is determined, the service technician or VDIS 306 may update the script 2502. If, however, the VDIS 306 was used in determining the resolution, then the vehicle data used to determine the resolution may be added to the script 2502 as well. Alternatively, the script 2502 may be designed to have the capability to suggest a potential solution and then ask whether the potential solution resolved the problem.

The script 2502 may implement quality-control measures against the updates so as to prevent erroneous information from destroying the usefulness of the script 2502. An expert tip master 2504 may be deployed to determine if the update is a valid update. The expert tip master 2504 may be a man or machine, and validation could be done iteratively through subsequent update entries.

(d) Exemplary Predictive-Diagnostics Application Architecture

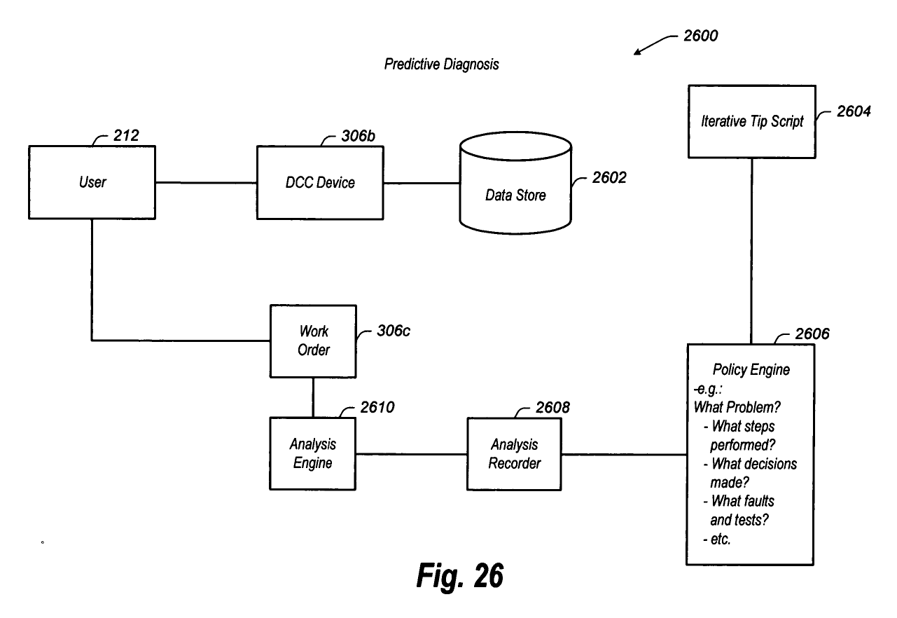

FIG. 26 is a block diagram illustrating an exemplary predictive-diagnostics application architecture 2600 for carrying out a predictive-diagnostics application in an ERP system, such as the ERP 300. The predictive-diagnostics application architecture 2600 may be carried out in a telematic, diagnostic and/or prognostic system, such as system 600, and/or vehicle diagnostic and information system, such as the VDIS 306.

The predictive-diagnostics application provides an output or determination that indicates a particular failure mode is going to occur at some point in the future. This determination is premised on statistical determination of potential failures using a (i) collection of vehicle data over a period of time, and (ii) statistical data collection of failure modes for the particular vehicle or vehicle-type under test.

For example, a refrigerated unit on a truck has been increasing its mean temperature by half a degree per day for the last couple of days. The predictive diagnostic application may output a determination that indicates that the compressor may fail in the near future. So the collection of vehicle data over a period two weeks is used to predict that the system is going to fail.

The predictive-diagnostics application architecture 2600 may include a DCC device 306b (or the ASP infrastructure 602), coupled to a data store 2602 containing a collection of vehicle data over a period of time and a statistical data collection of failure modes for the particular vehicle or vehicle-type under test. The predictive-diagnostics application architecture 2600 may also include several sources of information for creating the collection of vehicle data and the statistical data collection of failure modes.

One such source is an iterative tip script 2604, which may be an iterative form of the guided-diagnostics script 2502 (FIG. 25). A policy engine 2606 interrogates the iterative tip script to determine the actions taken and the resolutions determined. Data collected from the policy engine may be fed to an analysis recorder 2608 for recordation purposes. The analysis recorder 2608 may abstracts data without storing individual vehicle or other data about the vehicle under test.

An analysis engine 2610 may perform statistical analysis on the vehicle under test, and retain the statistics information rather than the actual data. The analysis engine 2610 may feed the statistical information to the work order application 306c, and on to the user 212 and/or the DCC device 306a. The DCC device 306a then stores the statistical information in the data store 2602 for later retrieval and analysis.

(e) Exemplary Workflow Architecture for Integration of Diagnostic Manuals

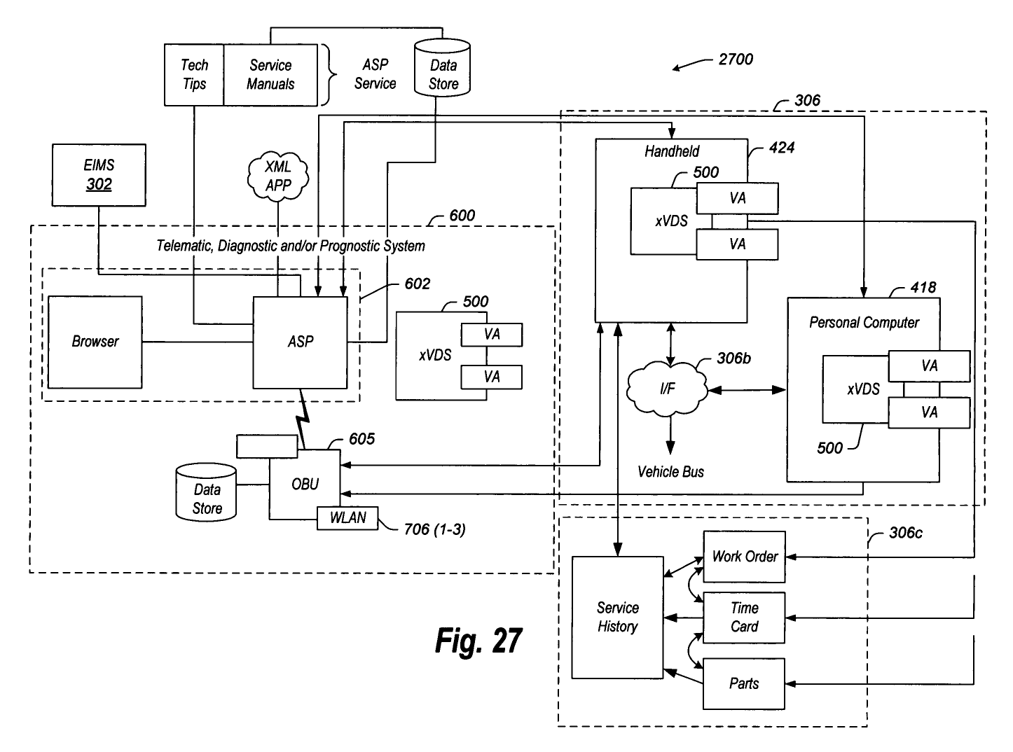

FIG. 27 is a block diagram illustrating a third workflow architecture 2700 for carrying out a vehicle servicing workflow in an enterprise-resource planning system, such as the ERP system 300. The third workflow architecture 2700 of FIG. 27 is similar to the first workflow architecture 2300 of FIG. 23 in most respects, except as described below.

In this workflow architecture 2700, a telematic, diagnostic and/or prognostic system, such as system 600, and a vehicle diagnostic and information system, such as the VDIS 306, may be configured to access and retrieve or download diagnostic manual information from a data store 2702. Alternatively, the system 600 and/or the VIDS 306 may subscribe or be configured to subscribe to an on-line service manual system, which may be embodied as an ASP service-manual system 2704.

This ASP service manual system 2704 may include an on-line ASP server 2704a for providing the service manual information to the ASP infrastructure 600 and/or the VDIS 306. The ASP service manual system 2704, like the ASP infrastructure 602, may have access, retrieve and update the information in the data store 2702.

The diagnostic manual information retrieved from the data store 2702 may be integrated into one or more of the vehicle applications so as to provide service manual information related to the vehicle data retrieved from the on-board electronics and electronic systems so as to aid in the diagnosis and repair of the vehicle. The service manual information may also be integrated with the guided-diagnostics application and/or the expert advice or tips system 2502.

(f) Exemplary Navigation Application

Given that the OBU 605 includes GPS system receiver and transceivers for two-way communication, users of the system 600 may report to a navigation application running on the ASP infrastructure 602 alert conditions external to the vehicle, such as a traffic jam or an accident. This report may be bundled with the GPS data so that the alert conditions may be pinpointed. This information may then be distributed to or accessed by other users of the system 600 to enable the other used to avoid the alert conditions.

(g) Exemplary Integrity Checks and Performance Monitoring

Included in the ASP infrastructure and the xVDS 500 are integrity-check and performance modules for detecting likely failure modes and performance of the system 600. For example, the integrity-check and performance modules may include a user notification if a file becomes corrupted or if the GPS receiver indicates movement when the ignition did not turn on, which may be an indication that an ignition wire in the OBU 605 is faulty. The integrity-check and performance modules may monitor for exception conditions, and send an alert to the off-vehicle portion of the system 600. Many other conditions, such as (i) the GPS transceiver is faulty, (ii) the OBU 605 cannot communicate the vehicle bus, (iii) the clock for the processor 300 chip is running slow, etc. Another alert may be implemented to note when a file system of the system 600 falls below certain thresholds. These thresholds may be set at about 10 percent, 5 percent, and 2 percent.

(h) Resolving Wireless Local Area Network Communications Differences

Given we said the OBU 605 may communicate over a wireless LAN, such as IEEE 802.11, to connect to the DCC Device 306a or the ASP Infrastructure 602, it may include an network access device, such as IEEE 802.11 card, to establish communications. These communications may be carried out in a peer-to-peer mode, point-to-point connection, or alternatively, in an infrastructure mode point-to-point connection. To resolve the potential for no connections, the OBU 605 and the ASP Infrastructure 602 may include a discovery application to determine the connection mode automate configuration of the OBU 605 and/or the ASP Infrastructure 602. To facilitate the proper connection, the discover application may display to a user a list that of available stations, i.e., network access devices, for selection. The discovery application may discover the available stations by broadcasting the name of the peer or client, a tag and/or security identifier. Then only OBUs that are equipped with a matching tag or security identifier can recognize the broadcast message. The OBUs that can recognize the tag and security identifier send a reply to the broadcast message. The discovery application can then build a list of available OBUs. This process, however, is not limited to OBUs, but may include other network access devices such as a wireless access point coupled to the ASP infrastructure 602. In an exemplary embodiment, the tag may be embodied as a vehicle identification number (VIN) given its uniqueness.

(i) Security Mechanism for Access to an OBU

The OBU 605 may be equipped with a number of security mechanisms to prevent unauthorized access. For example, a PKI-based infrastructure may be used to authorize access. The basis for PKI keys may be some function of a vehicle-identification number (VIN) of the vehicle 110 to which the OBU 605 is attached. The OBU 605 may be been assigned a public key and the DCC device 306a or the ASP infrastructure 602 may be assigned a private key. Alternatively, a security certificate may be used to minimize authentication routines. In either case, a replication mechanism and a revocation mechanism may be needed to properly institute a robust security mechanism.

9 Conclusion

Variations of the system described above are possible without departing from the scope of the invention. For example, selected applications may be run locally on proprietary equipment owned by the customers (i.e., the fleet managers, vehicle distributors, vehicle dealers and the like) as a stand alone software application instead of over the Internet. Further, the OBU 605 can be equipped with, for example, a bar code scanner and/or other human user interface to facilitate data capture. Other user interfaces and functions, such as a handheld diagnostics tool, workflow integration tool, links between data captured by different applications, and tools to provide advance warning of vehicle faults or pre-arrival diagnostics information may also be included as application modules or core services or even integrated within the application modules themselves. Note that one or more additional servers can also be incorporated into the system to, for example, accommodate additional data management functions and/or provide interfaces for integrating with existing applications.

Information obtained via the inventive system can also be used to, for example, re-calibrate vehicle components, perform firmware downloads, perform component failure analysis, determine wear characteristics, analyze quality of components used in their manufacturing processes, retrieve and manage warranty information, receive indications of vehicle maintenance needs, monitor vehicle use and abuse, and/or monitor lessee trip information, perform proactive data analysis, perform pre-arrival diagnostics, re-calibrate vehicle components, and/or perform firmware downloads. Note that this list of options is not exhaustive and those of skill in the art will understand that other variations in the data obtained via the system, and how the data is presented and used can vary without departing from the scope of the invention.

In view of the wide variety of embodiments that can be applied, it should be understood that the illustrated embodiments are exemplary only, and should not be taken as limiting the scope of the following claims. For instance, in the exemplary embodiments described herein include on-board vehicle systems and other vehicle mounted devices may include or be utilized with any appropriate voltage source, such as a battery, an alternator and the like, providing any appropriate voltage, such as about 12 Volts, about 24 Volts, about 42 Volts and the like.

Further, the embodiments described herein may be used with any desired system or engine. Those systems or engines may comprises items utilizing fossil fuels, such as gasoline, natural gas, propane and the like, electricity, such as that generated by battery, magneto, solar cell and the like, wind and hybrids or combinations thereof. Those systems or engines may be incorporated into other systems, such as an automobile, a truck, a boat or ship, a motorcycle, a generator, an airplane and the like.

In the embodiments described above, computing systems, controllers, and other devices containing processors are noted. These devices may contain at least one Central Processing Unit (“CPU”) and a memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the described methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It should be understood that the exemplary embodiments are not limited to the above-mentioned memories and that other platforms and memories may support the described methods.

Exemplary embodiments have been illustrated and described. Further, the claims should not be read as limited to the described order or elements unless stated to that effect. In addition, use of the term “means” in any claim is intended to invoke 35 U.S.C. §112, ¶ 6, and any claim without the word “means” is not so intended.

1. An enterprise-resource planning system comprising, in combination:
a first device adapted to obtain vehicle characteristic information from a vehicle, and to send the vehicle characteristic information over a communication link; and
a second device adapted to integrate the vehicle characteristic information into a information management system, wherein the second device is adapted to receive the vehicle characteristic information from the first device over the communication link, and wherein the first and second devices are operable to function as an enterprise resource planning system after integrating the vehicle diagnostic information into the information management system.

2. The system of claim 1, wherein the first device comprises a vehicle diagnostic and information system, and wherein the second device comprises an information processing system.

3. The system of claim 1, wherein the communication link is a wired link.

4. The system of claim 1, wherein the communication is a wireless link.

5. The system of claim 1, wherein the first device is operable to obtain the vehicle characteristic information from an electronic device positioned aboard a vehicle.

6. The system of claim 5, wherein the first device is operable to obtain the vehicle characteristic information from the electronic device using a second communication link.

7. The system of claim 6, wherein the second communication link is a wired communication link.

8. The system of claim 6, wherein the communication link is a wireless communication link.
